(19) United States
(12) Patent Application Publication
(10) Pub. No.: US 2018/0132071 A1
(43) Pub. Date: May 10, 2018

(54) METHOD AND TERMINAL FOR PERFORMING COMMUNICATION

(71) Applicant: Samsung Electronics Co., Ltd., Gyeonggi-do (KR)

(72) Inventors: Yun-sun BAEK, Gyeonggi-do (KR); Nishant GUPTA, Sitapur (IN)

(73) Assignee: Samsung Electronics Co., Ltd. and POCONS CO., LTD

(21) Appl. No.: 15/805,941

(22) Filed: Nov. 7, 2017

Related U.S. Application Data
(60) Provisional application No. 62/418,429, filed on Nov. 7, 2016.
(60) Provisional application No. 62/452,633, filed on Jan. 31, 2017.

(30) Foreign Application Priority Data
Mar. 21, 2017 (KR) 10-2017-0035508

(51) Int. Cl. H04W 4/08; H04L 29/06

(52) U.S. Cl. CPC H04W 4/08; H04L 65/4046

(57) ABSTRACT

A method, performed by a terminal, of performing communication is provided. The method includes receiving a transmission request message that requests a floor, wherein the floor is a right to transmit media, from at least one terminal, other than the terminal, included in a terminal group; in response to the transmission request message, determining a terminal for which a floor is revoked and a terminal that is granted a floor, within the terminal group, based on a result of a comparison between a number of floors granted before reception of the transmission request message and a maximum number of floors preset for the terminal group; and sending, to the terminal group, a message including information about the terminal for which a floor is revoked and the terminal that is granted a floor.

### PRIORITY

This application claims priority under 35 U.S.C. §119 to a U.S. Provisional Patent Application filed on Nov. 7, 2016 in the U.S. Patent and Trademark Office (USPTO) and assigned Ser. No. 62/418,429, a U.S. Provisional Patent Application filed on Jan. 31, 2017 in the USPTO and assigned Ser. No. 62/452,633, and a Korean Patent Application filed on Mar. 21, 2017 in the Korean Intellectual Property Office and assigned Serial No. 10-2017-0035508, the entire disclosure of each of which is incorporated herein by reference.

### BACKGROUND

### 1. Field of the Disclosure

The present disclosure relates generally to a method of performing communication, a terminal for performing communication, and a non-transitory computer-readable recording medium having recorded thereon a program for executing the method of performing communication, and more particularly, to a method of communicating by a terminal by receiving a transmission request message for a floor from at least one terminal in a terminal group other than the terminal.

### 2. Description of the Related Art

In recent years, as interest in a public safety network capable of providing communication services in emergency situations, such as disasters, has increased, research into a public safety network has been conducted. For example, research into providing communication services even in emergency situations via current communication technology, such as a public safety network based on Long Term Evolution (LTE), long term evolution has been being conducted.

In a case of a public safety network, network resources such as a server may not be supported, and thus off-network situations in which there are no central controllers should be considered. In other words, in the case of a public safety network, direct terminal-to-terminal communication should be considered.

Thus, in order to implement an off-network communication service, it is necessary to control transmission arbitration power, a floor, etc.

### SUMMARY

An aspect of the present disclosure provides methods and terminals for performing communication for controlling transmission arbitration power and a floor for media transmission in off-network situations.

Another aspect of the present disclosure provides that if a number of floors granted before a reception of a transmission request message is equal to a maximum number of floors preset for a terminal group, a priority of at least one other terminal that has sent the transmission request message is compared to a priority of a terminal that has been granted a floor before reception of the transmission request message, namely, a floor-already-granted terminal.

Another aspect of the present disclosure provides that if a priority of a floor-already-granted terminal is lower than a priority of at least one other terminal that has sent a transmission request message, the floor-already-granted terminal is determined as a terminal for which a floor is revoked and the at least one other terminal that has sent the transmission request message is determined to be the terminal that is granted a floor.

Another aspect of the present disclosure sends, to a terminal group, a floor-revoked message indicating that a floor of a floor-already-granted terminal is revoked; and sends, to the terminal group, a floor-granted message indicating that a floor of at least one other terminal that has sent a transmission request message is granted and may further include receiving media from the at least one other terminal that has sent the transmission request message.

Another aspect of the present disclosure provides that a terminal that has been granted a floor and is an arbitrator terminal having transmission arbitration power over a terminal group, if it is determined that a priority of the arbitrator terminal is lower than a priority of at least one other terminal that has sent a transmission request message, sends to the terminal group, a floor-revoked message indicating that a floor of the arbitrator terminal is revoked; and sends, to the terminal group, a floor-granted message indicating that the at least one other terminal that has sent the transmission request message has obtained a floor and transmission arbitration power, and If the floor-revoked message is transmitted, a media transmission by the terminal may be stopped.

Another aspect of the present disclosure provides receiving a transmission arbitration taken message indicating that at least one other terminal that has sent a transmission request message has obtained transmission arbitration power, from the at least one other terminal that has sent the transmission request message; in response to the transmission arbitration taken message, releasing the transmission arbitration power of the terminal; and receiving media from the at least one other terminal that has sent the transmission request message.

Another aspect of the present disclosure provides that if a number of floors granted before reception of a transmission request message is less than a maximum number of floors preset for a terminal group, sending, to the terminal group, a floor-granted message indicating that at least one other terminal that has sent a transmission request message is granted a floor.

Another aspect of the present disclosure provides sending, to a terminal group, a first transmission arbitration release message indicating that transmission arbitration power is delegated to a first terminal that is currently transmitting media from among a plurality of terminals; and if a response to the first transmission arbitration release message is not received, sending, to the terminal group, a second transmission arbitration release message indicating that transmission arbitration power is delegated to another terminal that is currently transmitting media, namely, a second terminal, wherein releasing the transmission arbitration power may include, if a transmission arbitration taken message is received from the second terminal, releasing the transmission arbitration power of the terminal.

According to an aspect of the present disclosure, a method, performed by a terminal, of performing communication is provided. The method includes receiving a transmission request message that requests a floor, wherein the floor is a right to transmit media, from at least one terminal, other than the terminal, included in a terminal group; in response to the transmission request message, determining a terminal for which a floor is revoked and a terminal that is granted a floor, within the terminal group, based on a result of a comparison between a number of floors granted before reception of the transmission request message and a maximum number of floors preset for the terminal group; and sending, to the terminal group, a message including information about the terminal for which a floor is revoked and the terminal that is granted a floor.

According to another aspect of the present disclosure, a method, performed by a terminal, of performing communication is provided. The method includes stopping transmitting of media by a terminal that has transmission arbitration power of a terminal group; sending, to the terminal group, a message indicating that the transmission arbitration power is delegated to another terminal that is currently transmitting media from among a plurality of terminals included in the terminal group; and releasing the transmission arbitration power of the terminal, based on whether a response to the sent message is received.

According to another aspect of the present disclosure, a terminal for performing communication is provided. The terminal includes a communicator configured to receive a transmission request message that requests a floor, wherein the floor is a right to transmit media, from at least one terminal, other than the terminal, included in a terminal group; and a processor configured to, in response to the transmission request message, determine a terminal for which a floor is revoked and a terminal that is granted a floor, within the terminal group, based on a result of a comparison between a number of floors granted before reception of the transmission request message and a maximum number of floors preset for the terminal group, wherein the communicator sends, to the terminal group, a message including information about at least one of the terminal for which a floor is revoked and the terminal that is granted a floor. According to another aspect of the present disclosure, a terminal for performing communication is provided. The terminal includes a processor configured to stop transmitting of media by a terminal that has transmission arbitration power of a terminal group; and a communicator configured to send, to the terminal group, a message indicating that the transmission arbitration power is delegated to another terminal that is currently transmitting media from among a plurality of terminals included in the terminal group, wherein the processor is further configured to release the transmission arbitration power of the terminal, based on whether a response to the sent message is received.

### BRIEF DESCRIPTION OF THE DRAWINGS

The above and other aspects, features, and advantages of the present disclosure will be more apparent from the following description, taken in conjunction with the accompanying drawings, in which:

FIG. 1 is a diagram of a method in which a terminal performs communication, according to an embodiment of the present disclosure;

FIG. 2 is a flow diagram of a method in which a terminal initializes transmission of a control message, according to an embodiment of the present disclosure;

FIG. 3 is a flow diagram of a method in which a terminal requests transmission permission, according to an embodiment of the present disclosure;

FIG. 4 is a flow diagram of a method of rejecting a transmission request from a terminal, according to an embodiment of the present disclosure;

FIG. 5 is a flow diagram of a method of releasing transmission permission of a terminal, according to an embodiment of the present disclosure;

FIG. 6 is a flowchart of a method in which a terminal determines another terminal that has a floor, according to an embodiment of the present disclosure;

FIG. 7 is a flow diagram of a method in which a terminal overrides transmission, according to an embodiment of the present disclosure;

FIG. 8 is a flow diagram of a method in which a terminal overrides transmission by using a floor-revoked message, according to an embodiment of the present disclosure;

FIG. 9 is a flow diagram of a method in which a terminal overrides transmission by itself, according to an embodiment of the present disclosure;

FIG. 10 is a flow diagram of a method in which a transmission arbitration-revoked terminal overrides transmission by using a floor-revoked message, according to an embodiment of the present disclosure;

FIG. 11 is a flow diagram of a method in which a terminal releases transmission arbitration power without delegation of the transmission arbitration power, according to an embodiment of the present disclosure;

FIG. 12 is a flow diagram of a method in which a terminal releases transmission arbitration power without delegation of transmission arbitration power, according to an embodiment of the present disclosure;

FIG. 13 is a flow diagram of a method in which a terminal releases its own transmission arbitration power while delegating the transmission arbitration power, according to an embodiment of the present disclosure;

FIG. 14 is a flow diagram of a method in which a terminal releases transmission arbitration power by using a transmission arbitration power delegation request, according to an embodiment of the present disclosure;

FIG. 15 is a flow diagram of a method of determining a transmission arbitrator, based on a transmission request message, if no transmission arbitrators exist in a terminal group, according to an embodiment of the present disclosure;

FIG. 16 is a flow diagram of a method of determining a transmission arbitrator, based on a transmission request message, if no transmission arbitrators exist in a terminal group, according to an embodiment of the present disclosure;

FIG. 17 is a flow diagram of a method in which a terminal requests information of a transmission arbitrator, according to an embodiment of the present disclosure;

FIG. 18 is a flow diagram of a method in which a terminal transmits media, based on a user's indication, in response to a transmission warning message that warns about interference occurrence, according to an embodiment of the present disclosure;

FIG. 19 is a flow diagram of a method in which a terminal determines transmission of media, based on a user's indication, in response to a transmission warning message that warns about interference occurrence, according to an embodiment of the present disclosure;

FIG. 20 is a flow diagram of a method in which a terminal determines transmission of media, based on an interference mode, in response to a transmission warning message that warns about interference occurrence, according to an embodiment of the present disclosure;

FIG. 21 is a flow diagram of a method in which a terminal determines transmission of media, based on a transmission commencement mode, in response to a transmission warning message that warns about interference occurrence, according to an embodiment of the present disclosure;

FIG. 22 is a flow diagram of a method in which a terminal determines transmission of media, based on transmission priority, in response to a transmission warning message that warns about interference occurrence, according to an embodiment; and

FIG. 23 is a block diagram of a terminal according to an embodiment of the present disclosure.

### DETAILED DESCRIPTION OF EMBODIMENTS OF THE PRESENT DISCLOSURE

Hereinafter, the terms used in the present disclosure are briefly described, and then the present disclosure is described in detail.

Although general terms widely used at present were selected for describing the present disclosure in consideration of the functions thereof, these general terms may vary according to intentions of one of ordinary skill in the art, case precedents, the advent of new technologies, and the like. Terms arbitrarily used in the present disclosure may also be used in a certain case. In this case, their meanings may be given in the detailed description of the present disclosure. Hence, the terms may be defined based on their meanings and the contents of the present disclosure, not by simply stating the terms.

The terms “comprises,” “comprising,” “includes,” and “including,” if used in the present disclosure, indicate the presence of stated elements, but do not preclude the presence or addition of one or more other elements. The terms “. . . unit” and “. . . module” if used in the present disclosure indicates a unit in which at least one function or operation is performed, and may be implemented as hardware, software, or a combination of hardware and software.

Embodiments of the present disclosure are described in detail herein with reference to the accompanying drawings so that present disclosure may be easily implemented by one of ordinary skill in the art to which the present disclosure pertains. The present disclosure may, however, be embodied in different forms and is not intended be construed as being limited to the embodiments set forth herein. In the accompanying drawings, parts irrelevant to the description are omitted for simplicity of explanation, and like numbers refer to like elements throughout.

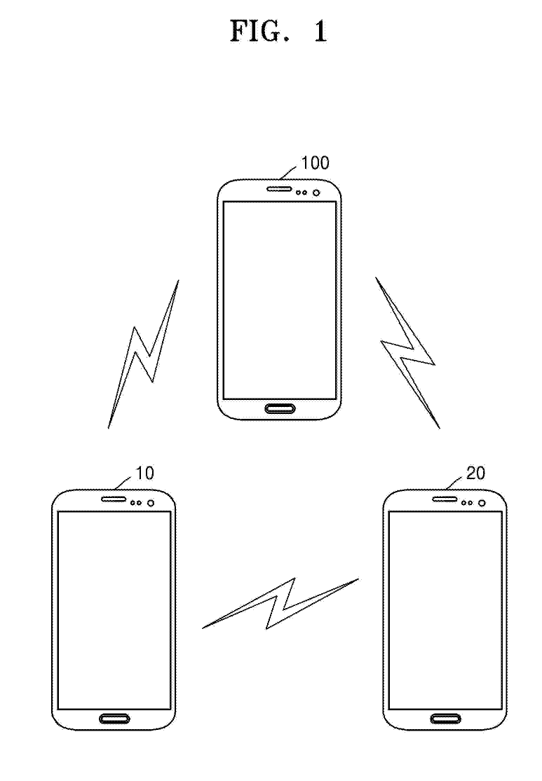

FIG. 1 is a diagram of a method in which a terminal 100 performs communication, according to an embodiment of the present disclosure.

Referring to FIG. 1, the terminal 100 may communicate with at least one terminal, namely, terminals 10 and 20, included in a terminal group in a long term evolution (LTE)-based public safety network, which is referred to as a public safety LTE (PS-LTE).

The LTE-based public safety network, in which the terminal 100 performs communication, may include an off-network. In the off-network, a user of the terminal 100 may make a direct comment without using a network infrastructure. In other words, in the off-network, a user of the terminal 100 may talk according to a predetermined rule without support of a server that controls communication (i.e., approval of a floor) unlike the on-network. Accordingly, the off-network may be used for communication between users in an environment in which no network infrastructure has been established or in a certain situation in which appropriate support cannot be provided by a network infrastructure.

To perform communication with other terminals included in a terminal group with respect to which a communication session is set, in an off-network, the terminal 100 may transmit or receive, to or from the terminal 10 or 20 included in the terminal group, at least one of a transmission request message, a transmission granted message, a transmission release message, a transmission rejected message, a transmission revoked message, a transmission taken message, a transmission arbitration taken message, a transmission arbitration release message, a transmission arbitration information request message, a transmission arbitration information response message, a transmission arbitration delegation request message, and a transmission warning message. The messages may be exchanged among the terminals 10, 20, and 100 within the terminal group according to at least one method from among multicast, unicast, and broadcast. However, this is only an example, and the messages transmitted or received by the terminal 100 are not limited thereto.

According to the exchange of the above-described messages, the terminal 100 that has obtained a floor may transmit media to the terminals 10 and 20 included in the terminal group. The media may include at least one of video data and audio data, but the media is not limited to the aforementioned examples.

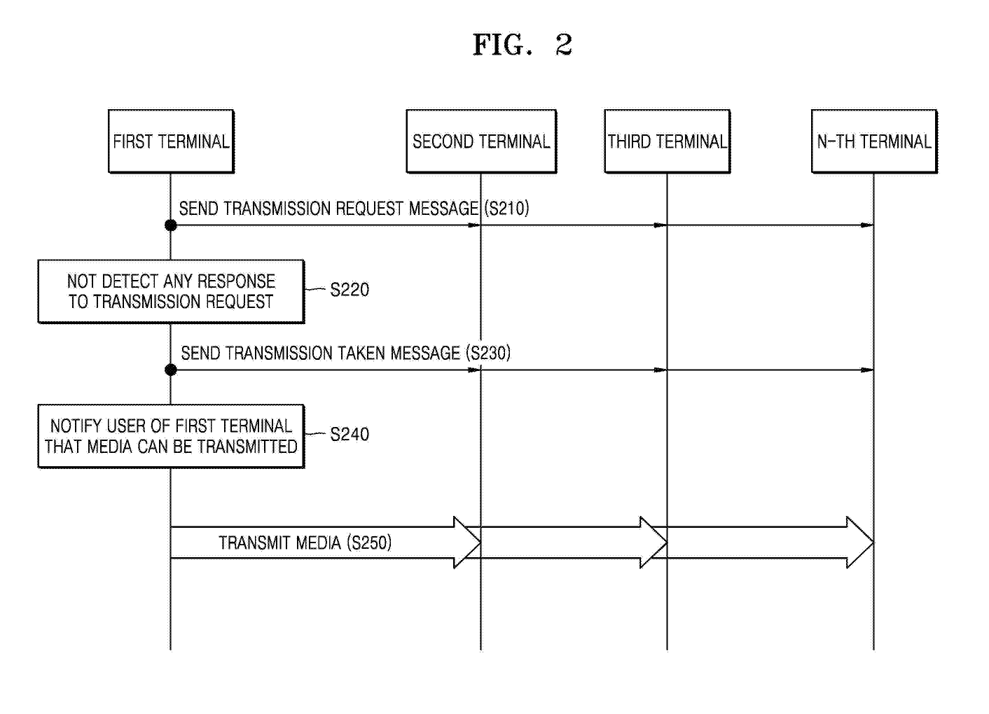

FIG. 2 is a flow diagram of a method in which a terminal initializes transmission of a control message, according to an embodiment of the present disclosure.

Referring to FIG. 2, initially, an off-network group communication is established and no terminals are transmitting media.

In step S210, a first terminal may send a transmission request message to a terminal group (e.g., a second terminal, a third, terminal, . . . , and an n^{th} terminal).

In step S220, the first terminal may not detect any response to the transmission request.

In step S230, the first terminal may send a transmission taken message to the terminal group.

The first terminal according to an embodiment of the present disclosure may send the transmission taken message to the terminal group if the first terminal does not receive a response to the transmission request. If the first terminal sends a transmission taken message to the terminal group, the first terminal may be determined to be a transmission arbitrator.

According to an embodiment of the present disclosure, if the first terminal as a transmission arbitrator later receives a transmission request message from another terminal within the terminal group, the first terminal may determine whether a floor for the other terminal is to be granted. For example, if the number of floors already granted for the terminal group is not a maximum number of floors capable of being granted simultaneously, the first terminal may grant the floor for the other terminal. Even if the other terminal has a higher priority than the first terminal as a transmission arbitrator, the transmission arbitrator may be maintained. However, this is only an example, and, according to an embodiment of the present disclosure, the transmission arbitrator may be changed according to the priority.

According to an embodiment of the present disclosure, the first terminal may send a transmission arbitration taken message instead of a transmission taken message. If the first terminal sends a transmission arbitration taken message to the terminal group, the first terminal may be determined to be a transmission arbitrator.

In step S240, the first terminal may notify a user of the first terminal that the media may be transmitted.

In step S250, the first terminal may transmit the media to the terminal group.

The first terminal may transmit the media to the terminal group if the first terminal is determined to be a transmission arbitrator.

Although steps S230 and S240 are described above in a stated order, the order of of the steps is not limited thereto.

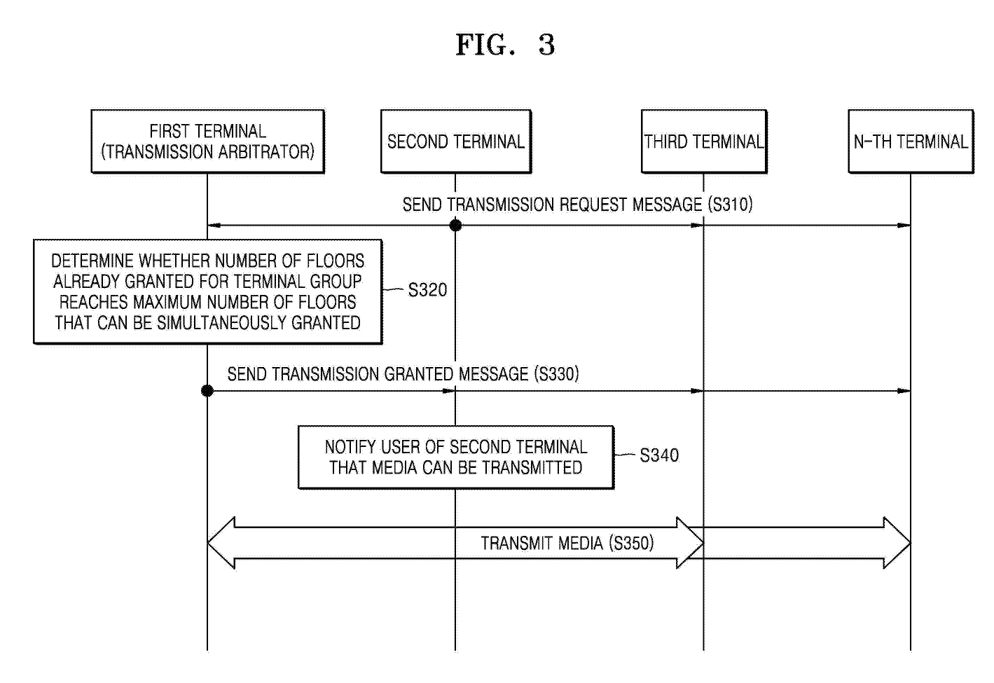

FIG. 3 is a flow diagram of a method in which a terminal requests transmission permission, according to an embodiment of the present disclosure.

Referring to FIG. 3, initially, an off-network group communication is established and at least one terminal included in a terminal group is transmitting media.

In step S310, a second terminal may send a transmission request message to the terminal group (e.g., a first terminal, a third terminal, . . . , and an n^{th} terminal).

The second terminal may determine that a transmission arbitrator exists in the terminal group. For example, the second terminal may determine that a transmission arbitrator exists in the terminal group by receiving a control message from a transmission arbitrator.

If a transmission arbitrator exists, the second terminal may send a transmission request message and wait for a response to the transmission request message, in order to receive transmission permission. For example, the second terminal may send the transmission request message to the terminal group in unicast or broadcast.

The transmission request message according to an embodiment of the present disclosure may include information elements (IEs) such as an MCVideo identity (ID), a transmission priority, and a source identifier. The MCVideo ID may indicate identification information of a terminal that requests transmission or a user of the terminal. The transmission priority may indicate a priority of a request. The source identifier may indicate an identifier of a communication. For example, if media has been multiplexed, an identifier of a terminal that has transmitted the media may be included in a source identifier in order to identify the media within the multiplexed media.

In step S320, the first terminal may determine whether a number of floors already granted for the terminal group reaches a maximum number of floors that can be simultaneously granted. In an embodiment of the present disclosure, the first terminal is a transmission arbitrator.

Floor contention according to an embodiment of the present disclosure may occur if multiple floor requests exist simultaneously. If multiple floor requests exist simultaneously, the first terminal may serve as a floor arbitrator by comparing a priority of the first terminal to a priority included in a transmission request message received from another terminal.

In step S330, if the first terminal determines that the number of floors already granted for the terminal group does not reach the maximum number of floors that can be simultaneously granted, the first terminal may send a transmission granted message to the terminal group. For example, the first terminal may send a transmission granted message to the terminal group in unicast or broadcast. The transmission granted message may indicate that transmission by the second terminal is granted.

A transmission granted message may include an MCVideo ID of a transmission arbitrator, an MCVideo ID of a granted party, a duration, a source identifier, an MCVideo ID of a subsequent arbitrator, and an acknowledgement required. An MCVideo ID of a transmission arbitrator may indicate identification information of a transmission arbitrator, and an MCVideo ID of a granted party may indicate an identification information of a terminal that was granted a transmission. A duration may indicate a time period during which a granted party is allowed to transmit. A source identifier may indicate an identifier of a communication. For example, if media has been multiplexed, a source identifier may be used to identify the media within the multiplexed media. An MCVideo ID of a subsequent arbitrator may indicate identification information of a subsequent transmission arbitrator, and an acknowledgement required may indicate whether acknowledgement from a transmission participant (for example, a transmission terminal) is required.

In step S340, the second terminal may notify a user of the second terminal that the media may be transmitted.

In step S350, the second terminal may transmit the media to the terminal group.

The second terminal may transmit the media to the terminal group if the second terminal receives the transmission granted message.

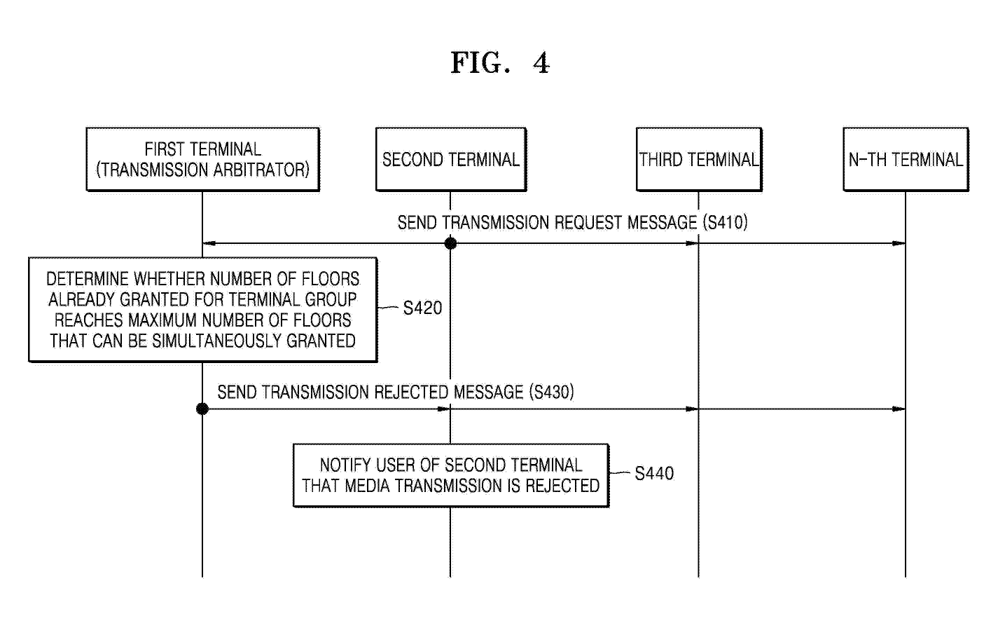

FIG. 4 is a flow diagram of a method of rejecting a transmission request from a terminal, according to an embodiment of the present disclosure.

Referring to FIG. 4, initially, an off-network group communication is established and at least one terminal included in a terminal group is currently transmitting media.

In step S410, a second terminal may send a transmission request message to the terminal group (e.g., a first terminal, a third, terminal, . . . , and an n^{th} terminal). The second terminal may determine that a transmission arbitrator for the terminal group exists. For example, the second terminal may determine that a transmission arbitrator exists in the terminal group by receiving a control message from a transmission arbitrator.

If a transmission arbitrator exists, the second terminal may send a transmission request message and wait for a response to the transmission request message in order to receive transmission permission.

In step S420, the first terminal, being the transmission arbitrator, may determine whether a number of floors already granted for the terminal group reaches a maximum number of floors that can be simultaneously granted.

In step S430, if the first terminal determines that the number of floors already granted for the terminal group has reached the maximum number of floors that can be simultaneously granted, the first terminal may send a transmission rejected message to the terminal group. For example, the first terminal may send the transmission rejected message to the terminal group in unicast or broadcast. The transmission rejected message may indicate that transmission by the second terminal is rejected.

The transmission rejected message may include an MCVideo ID of a transmission arbitrator, an MCVideo ID of a rejected party, a source identifier, a rejection cause, and an acknowledgement required. An MCVideo ID of a transmission arbitrator may indicate identification information of the transmission arbitrator, and a rejected party may indicate identification information of a transmission-rejected terminal. A source identifier may indicate an identifier of a communication. For example, if media has been multiplexed, a source identifier may be used to identify the media within the multiplexed media. A rejection cause may indicate a cause for transmission rejection, and an acknowledgement required may indicate whether an acknowledgement from a transmission participant (a terminal) is required.

In step S440, the second terminal may notify a user of the second terminal that media transmission is rejected.

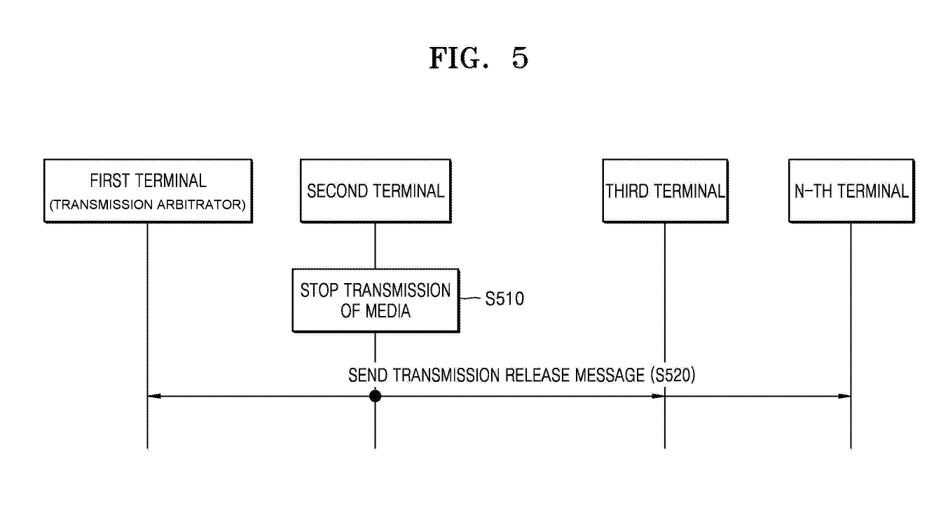

FIG. 5 is a flow diagram of a method of releasing transmission permission of a terminal, according to an embodiment of the present disclosure.

Referring to FIG. 5, initially, an off-network group communication is established and a second terminal included in a terminal group has requested and received transmission permission.

In step S510, the second terminal may stop transmission of the media.

The second terminal may stop transmitting the media if transmission is permitted.

In step S520, the second terminal may send a transmission release message to the terminal group.

A transmission arbitrator (for example, the first terminal) according to an embodiment of the present disclosure may not respond to a pending transmission request if the transmission release message is received from the second terminal. The pending transmission request may indicate a not granted or a denied transmission request.

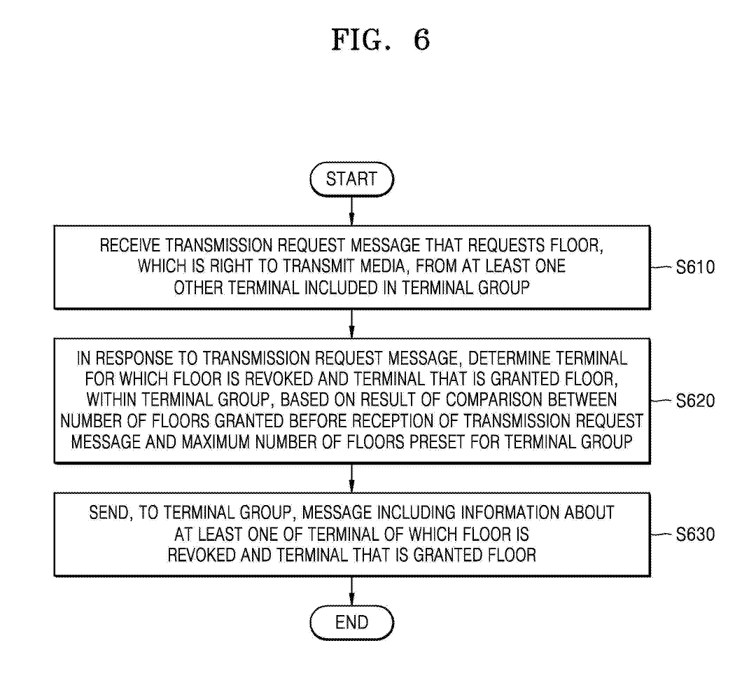

FIG. 6 is a flowchart of a method in which a terminal determines a terminal that has a floor, according to an embodiment of the present disclosure.

Referring to FIG. 6, in step S610, a terminal included in a terminal group may receive a transmission request message that requests a floor, which is a right to transmit media, from at least one other terminal included in the terminal group.

According to an embodiment of the present disclosure, the terminal is a transmission arbitrator capable of determining whether to grant a floor of another terminal within the terminal group that has requested a floor.

In step S620, in response to the transmission request message, the terminal may determine a terminal for which a floor is revoked and a terminal that is granted a floor, within the terminal group, based on a result of a comparison between a number of floors granted before reception of the transmission request message and a maximum number of floors preset for the terminal group.

In response to the transmission request message, the terminal may determine whether the number of floors already granted for the terminal group reaches the maximum number of floors preset for the terminal group.

If the number of floors already granted for the terminal group has reached the maximum number of floors preset for the terminal group, the terminal may compare the priority of a terminal that has already been granted a floor to the priority of another terminal that has sent a transmission request message, in order to re-determine a terminal having a floor. If the priority of the first terminal from among at least one terminal already granted a floor is less than the priority of another terminal that has sent a transmission request message, the terminal may revoke the floor of the first terminal. Accordingly, the terminal that has sent the transmission request message may be granted a floor.

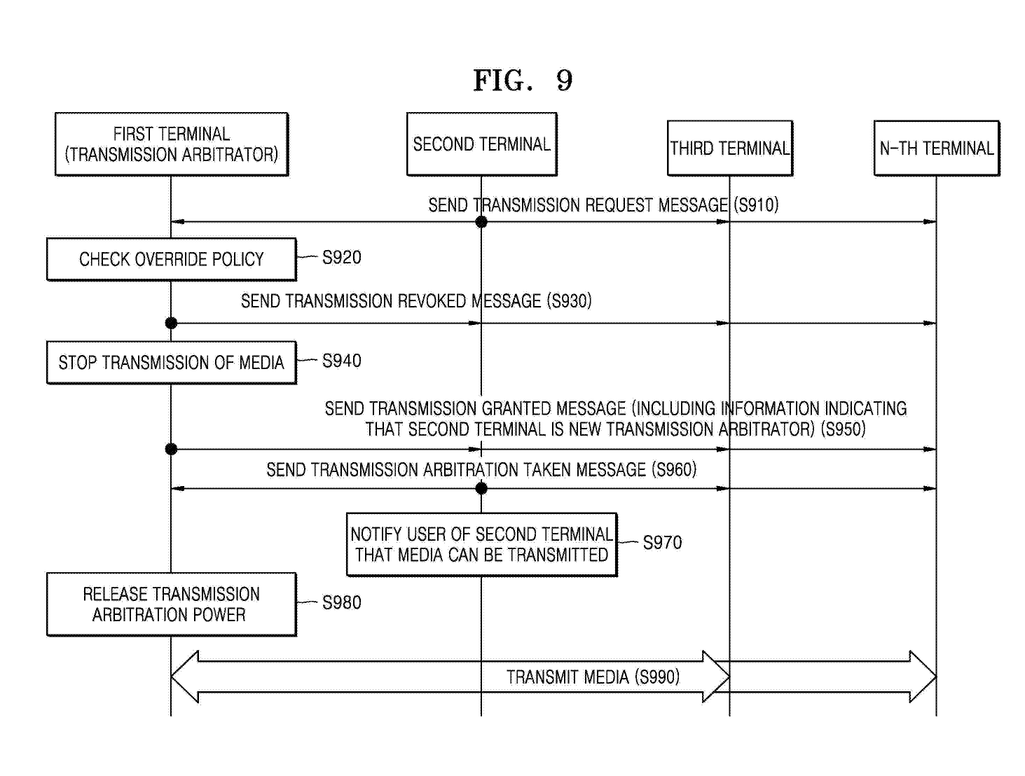

If the terminal that is a transmission arbitrator has a lesser priority than the terminal that has sent the transmission request message, the terminal may delegate a transmission arbitrator while granting a floor of the terminal that has sent the transmission request message. This is described in greater detail below with reference to FIG. 9.

According to an embodiment of the present disclosure, priority is used as an override policy for determining a terminal for which a floor is revoked. However, this is only an example, and the present disclosure is not limited to the use of priority as an override policy.

In step S630, the terminal may send, to the terminal group, a message including information about at least one of a terminal of which a floor is revoked and a terminal that is granted a floor.

The terminal may send a transmission revoked message to the terminal group in order to provide information about a terminal of which a floor is determined to be revoked. The terminal may send a transmission granted message including information about a terminal that has been granted a floor. This is only an example, and, according to an embodiment of the present disclosure, a terminal may include information about a terminal that has been granted a floor and a terminal of which a floor has been revoked, in a transmission granted message, and may send the transmission granted message to the terminal group.

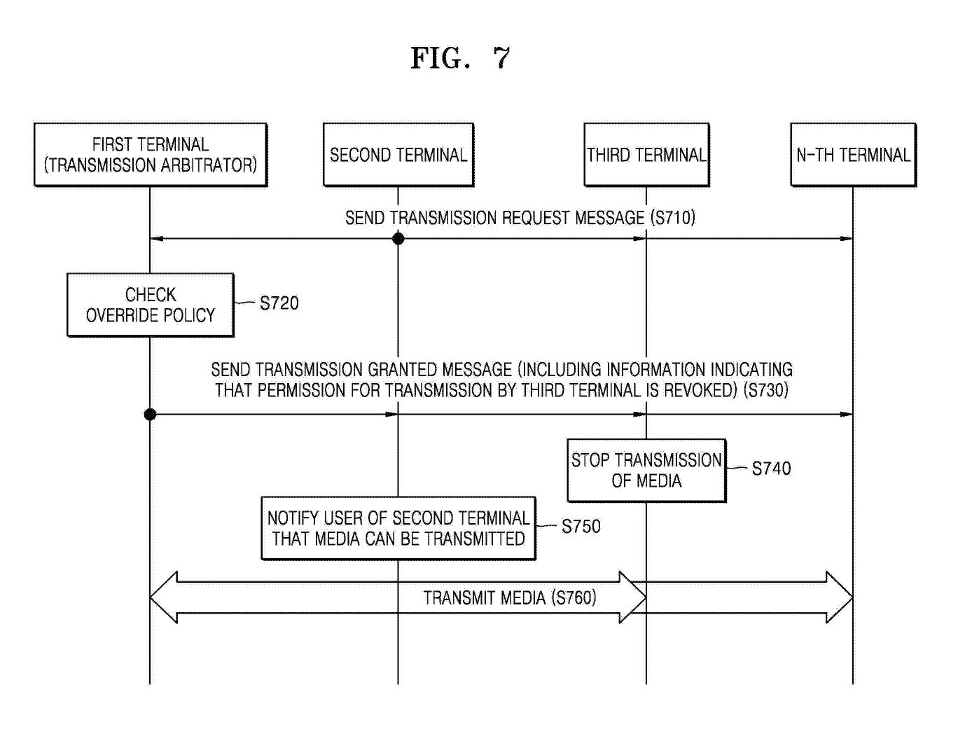

FIG. 7 is a flow diagram of a method in which a terminal overrides transmission, according to an embodiment of the present disclosure.

Referring to FIG. 7, initially, an off-network group communication is established and a number of floors already granted for a terminal group has reached a maximum number of floors that can be simultaneously granted.

In step S710, a second terminal may send a transmission request message to the terminal group.

In step S720, a first terminal, being a transmission arbitrator, may check an override policy since the number of floors already granted for the terminal group has reached the maximum number of floors that can be simultaneously granted.

In step S730, if the first terminal determines, based on the override policy, that the second terminal is authorized to transmit media, the first terminal may send a transmission granted message to the terminal group. The transmission granted message may include information indicating that transmission by the second terminal is granted and permission for transmission by the third terminal is revoked. The third terminal may be a terminal that has already been granted transmission permission.

The override policy may be determined based on priorities of a plurality of terminals included in the terminal group. For example, according to the override policy, the second terminal having a greater priority may receive transmission permission before the third terminal. However, this is only an example, and the override policy is not limited thereto.

In step S740, the third terminal may stop transmitting media, and may notify a user of the third terminal that the transmission permission has been revoked.

In step S750, the second terminal may notify a user of the second terminal that media may be transmitted.

While steps S740 and S750 are described above in a stated order, steps S740 and S750 may be performed simultaneously, or step S750 may be performed prior to step S740.

In step S760, the second terminal may transmit media to the terminal group.

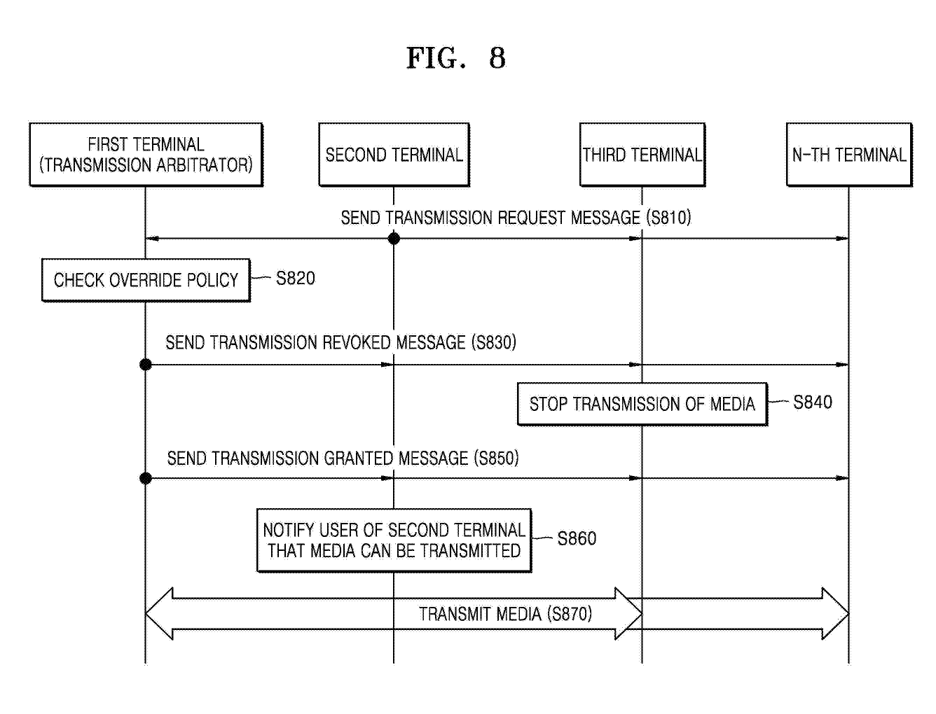

FIG. 8 is a flow diagram of a method in which a terminal overrides transmission by using a transmission revoked message, according to an embodiment of the present disclosure.

Referring to FIG. 8, initially, an off-network group communication is established and a number of floors already granted for a terminal group has reached a maximum number of floors that can be granted simultaneously.

In step S810, a second terminal may send a transmission request message to the terminal group (e.g., a first terminal, a third, terminal, . . . , and an n^{th} terminal).

In step S820, a first terminal as a transmission arbitrator may check an override policy since the number of floors already granted for the terminal group has reached the maximum number of floors that can be granted simultaneously.

In step S830, if the first terminal determines, based on the override policy, that the second terminal is authorized to transmit media, the first terminal may send, to the terminal group, a transmission revoked message for revoking transmission permission for a terminal that has already been granted the transmission. For example, the first terminal may send the transmission revoked message to the terminal group in unicast or broadcast. The transmission revoked message may include information indicating that transmission by the third terminal is revoked, because transmission by another terminal is granted.

The transmission revoked message may include an MCVideo ID of a transmission arbitrator, an MCVideo ID of a revoked party, a source identifier, and an acknowledgement required. The MCVideo ID of the transmission arbitrator may indicate identification information of the transmission arbitrator, and the revoked party may indicate identification information of a transmission-revoked terminal. The source identifier may indicate an identifier of the communication. For example, if media has been multiplexed, the source identifier may be used to identify media within the multiplexed media. The acknowledgement required may indicate whether an acknowledgement from a transmission participant (e.g., a transmission terminal) is required.

An override policy may be determined based on priorities of a plurality of terminals included in the terminal group. For example, according to the override policy, the second terminal having a greater priority may receive transmission permission before the third terminal. However, this is only an example, and the override policy is not limited thereto.

In step S840, a third terminal may stop transmitting media, and may notify a user of the third terminal that the transmission permission has been revoked.

In step S850, the first terminal may send a transmission granted message to the terminal group. The transmission granted message may include information indicating that transmission by the second terminal is granted.

In step S860, the second terminal may notify a user of the second terminal that the media may be transmitted.

In step S870, the second terminal may transmit the media to the terminal group.

FIG. 9 is a flow diagram of a method in which a terminal overrides transmission by itself, according to an embodiment of the present disclosure.

Referring to FIG. 9, initially, an off-network group communication is established and a number of floors already granted for a terminal group has reached a maximum number of floors that can be granted simultaneously.

In step S910, a second terminal may send a transmission request message to the terminal group (e.g., a first terminal, a third terminal, . . . , and an n^{th} terminal).

In step S920, a first terminal as a transmission arbitrator may check an override policy since the number of floors already granted for the terminal group has reached the maximum number of floors that can be granted simultaneously.

In step S930, if the first terminal determines, based on the override policy, that the second terminal is authorized to override, the first terminal may send a transmission revoked message to the terminal group. According to the present embodiment of the present disclosure, the transmission revoked message may include information indicating that permission for the first terminal is revoked.

The override policy may be determined based on priorities of a plurality of terminals included in the terminal group. For example, according to the override policy, the second terminal having a greater priority may receive transmission permission before the first terminal. However, this is only an example, and the override policy is not limited thereto.

According to an embodiment of the present disclosure, another terminal that is currently transmitting media to the terminal group may exist.

A transmission arbitrator subsequent to the first terminal may be determined according to a priority of the other terminal and a priority of the second terminal. For example, if the other terminal has a greater priority than the second terminal, the other terminal may be determined as a transmission arbitrator. For example, if the other terminal has a lesser priority than the second terminal, the second terminal may be determined as a transmission arbitrator.

In step S940, the first terminal may stop transmitting media, and may notify a user of the first terminal that the transmission permission has been revoked.

In step S950, the first terminal may send a transmission granted message to the terminal group. The transmission granted message may include information indicating that the second terminal is a new transmission arbitrator.

In step S960, the second terminal may send a transmission arbitration taken message to the terminal group.

In step S970, the second terminal may notify a user of the second terminal that media may be transmitted.

While steps S960 and S970 are described above in the stated order, steps S960 and S970 may be performed simultaneously, or step S970 may be performed prior to step S960.

In step S980, in response to the transmission arbitration taken message, the first terminal may release transmission arbitration power.

In step S990, the second terminal may transmit media to the terminal group.

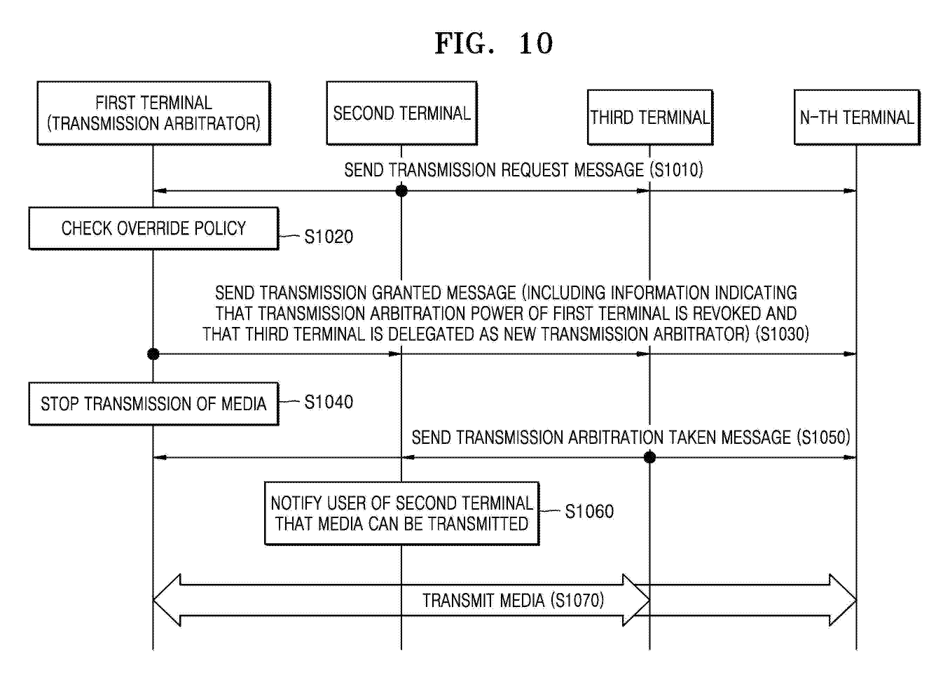

FIG. 10 is a flow diagram of a method in which a transmission arbitration-revoked terminal overrides transmission by using a transmission granted message, according to an embodiment of the present disclosure.

Referring to FIG. 10, initially, an off-network group communication is established and a number of floors already granted for a terminal group has reached a maximum number of floors that can be granted simultaneously.

In step S1010, a second terminal may send a transmission request message to the terminal group (e.g., a first terminal, a third terminal, . . . , and an n^{th} terminal).

In step S1020, a first terminal as a transmission arbitrator may check the override policy since the number of floors already granted for the terminal group has reached the maximum number of floors that can be granted simultaneously.

In step S1030, the first terminal may send a transmission granted message to the terminal group. The transmission granted message may include information indicating that transmission arbitration power of the first terminal is revoked and that a third terminal is delegated as a new transmission arbitrator.

In step S1040, the first terminal may stop transmitting media, and may notify a user of the first terminal that the transmission permission has been revoked.

In step S1050, the third terminal may send a transmission arbitration taken message to the terminal group.

In step S1060, the second terminal may notify a user of the second terminal that media may be transmitted.

While steps S1050 and S1060 are described above in the stated order, steps S1050 and S1060 may be performed simultaneously, or step S1060 may be performed prior to step S1050.

In step S1070, the second terminal may transmit media to the terminal group.

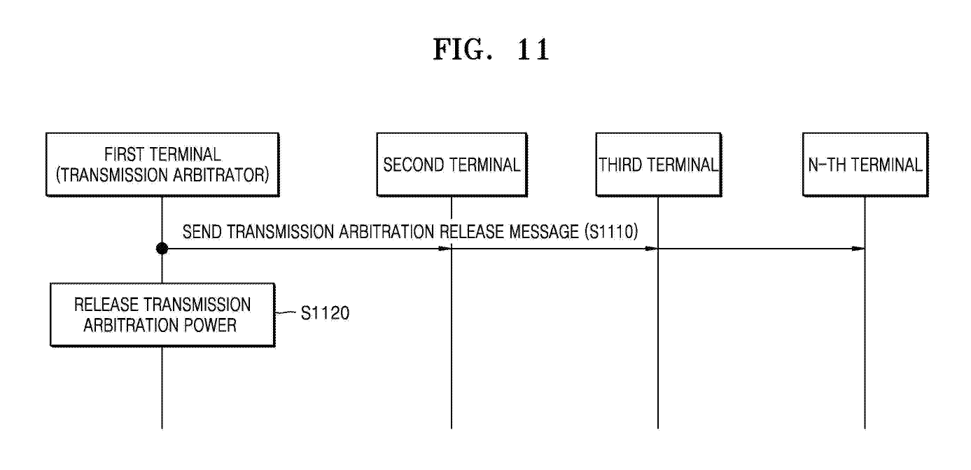

FIG. 11 is a flow diagram of a method in which a terminal releases transmission arbitration power without delegation of the transmission arbitration power, according to an embodiment of the present disclosure.

Referring to FIG. 11, initially, an off-network group communication is established and only a first terminal included in a terminal group is currently transmitting media.

In step S1110, the first terminal may send a transmission arbitration release message to the terminal group (e.g., a second terminal, a third terminal, . . . , and an n^{th} terminal).

In step S1120, the first terminal may release transmission arbitration power. If the transmission arbitration power is released, the first terminal may stop transmission of the media.

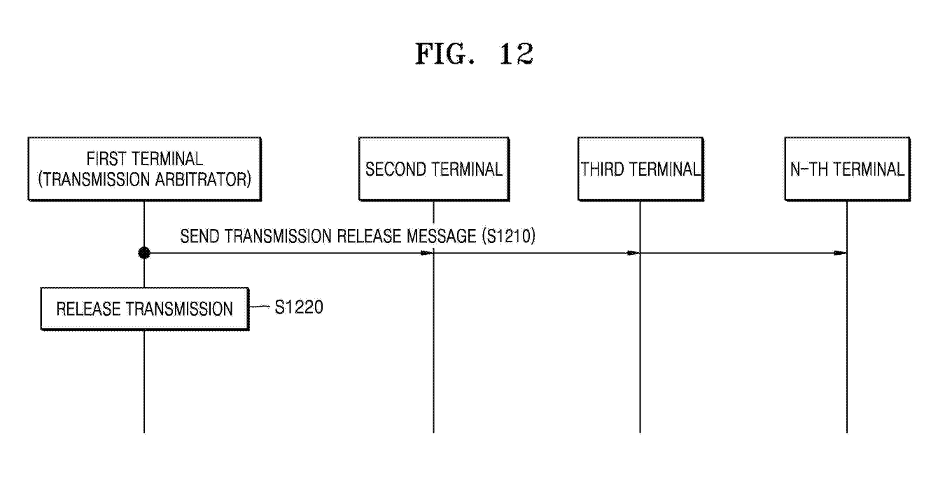

FIG. 12 is a flow diagram of a method in which a terminal releases transmission arbitration power without delegation of transmission arbitration power, according to an embodiment of the present disclosure.

Referring to FIG. 12, initially, an off-network group communication is established and only a first terminal included in a terminal group is currently transmitting media.

In step S1210, a first terminal may send a transmission release message to the terminal group (e.g., a second terminal, a third terminal, . . . , and an n^{th} terminal). The transmission release message may indicate that transmission is released as media transmission by a transmission participant is completed. The first terminal may send the transmission release message to the terminal group in unicast or broadcast.

The transmission release message may include an MCVideo ID and a source identifier. The MCVideo ID may indicate identification information of a terminal that releases transmission or a user of a terminal. The source identifier may indicate an identifier of a communication. For example, if media has been multiplexed, the source identifier may be used to identify media within the multiplexed media.

In step S1220, as transmission is released, the first terminal may stop transmission of the media.

As terminals other than the first terminal included in the terminal group receives the transmission release message from the first terminal, being a transmission arbitrator, the other terminals may release the current transmission arbitrator.

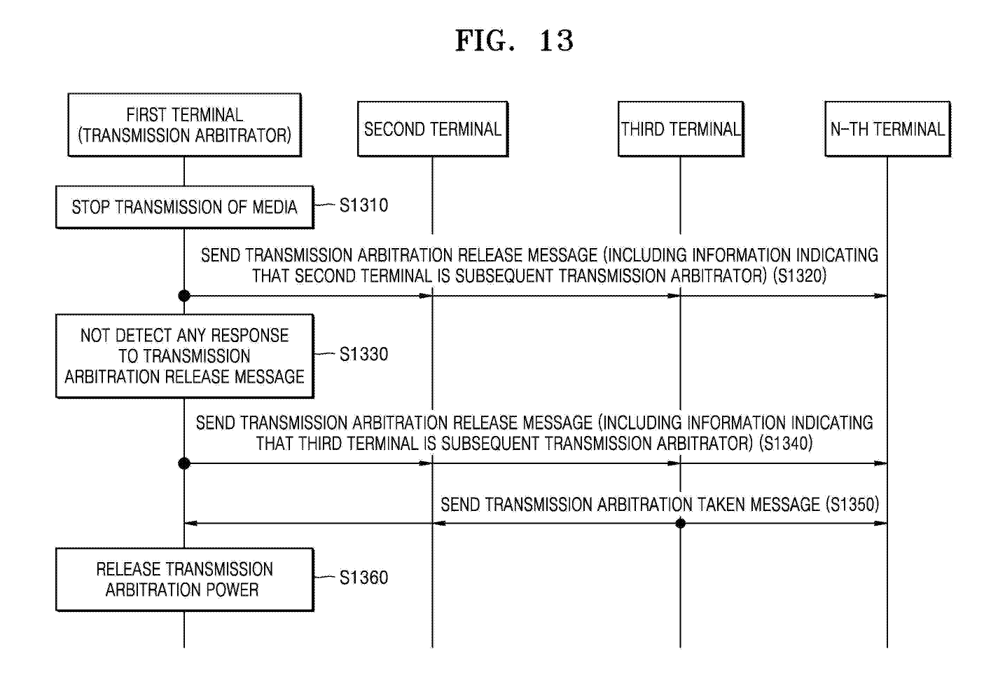

FIG. 13 is a flow diagram of a method in which a terminal releases its own transmission arbitration power while delegating the transmission arbitration power, according to an embodiment of the present disclosure.

Referring to FIG. 13, initially, an off-network group communication is established and at least one terminal other than a first terminal, being a current transmission arbitrator, included in a terminal group is currently transmitting media.

In step S1310, the first terminal may stop transmission of the media. Then, the first terminal may only stop transmission of the media but may not release its own transmission arbitration power.

In step S1320, the first terminal may send a transmission arbitration release message to the terminal group (e.g., a second terminal, a third, terminal, . . . , and an n^{th} terminal). The transmission arbitration release message may include information indicating that a second terminal that is currently transmitting media is a subsequent transmission arbitrator. The first terminal may wait for a confirmation without releasing transmission arbitration power before receiving a response to the transmission arbitration release message.

In step S1330, the first terminal may not detect any response from the second terminal.

In step S1340, the first terminal may send another transmission arbitration release message to the terminal group. The transmission arbitration release message may include information indicating that a third terminal that is currently transmitting media is a subsequent transmission arbitrator. The first terminal may wait for a confirmation without releasing transmission arbitration power before receiving a response to the transmission arbitration release message.

In step S1350, the third terminal may send a transmission arbitration taken message to the terminal group.

The transmission arbitration taken message may be used similarly to the transmission taken message. Terminals other than the third terminal that have received the transmission arbitration taken message may determine whether the third terminal is a new transmission arbitrator.

The transmission arbitration taken message may include IEs, such as an MCVideo ID, a source identifier, permission to request transmission, and an acknowledgement required. The MCVideo ID may indicate identification information of a terminal that has obtained transmission arbitration power. The source identifier may indicate an identifier of a communication. For example, if media has been multiplexed, a source identifier may be used to identify media within the multiplexed media. The permission to request the transmission may indicate whether participants that have requested the transmission are allowed to request the transmission or not. The acknowledgement required may indicate whether acknowledgement from a transmission participant is required.

In step S1360, if the transmission arbitration taken message is received from the third terminal, the first terminal may release transmission arbitration power.

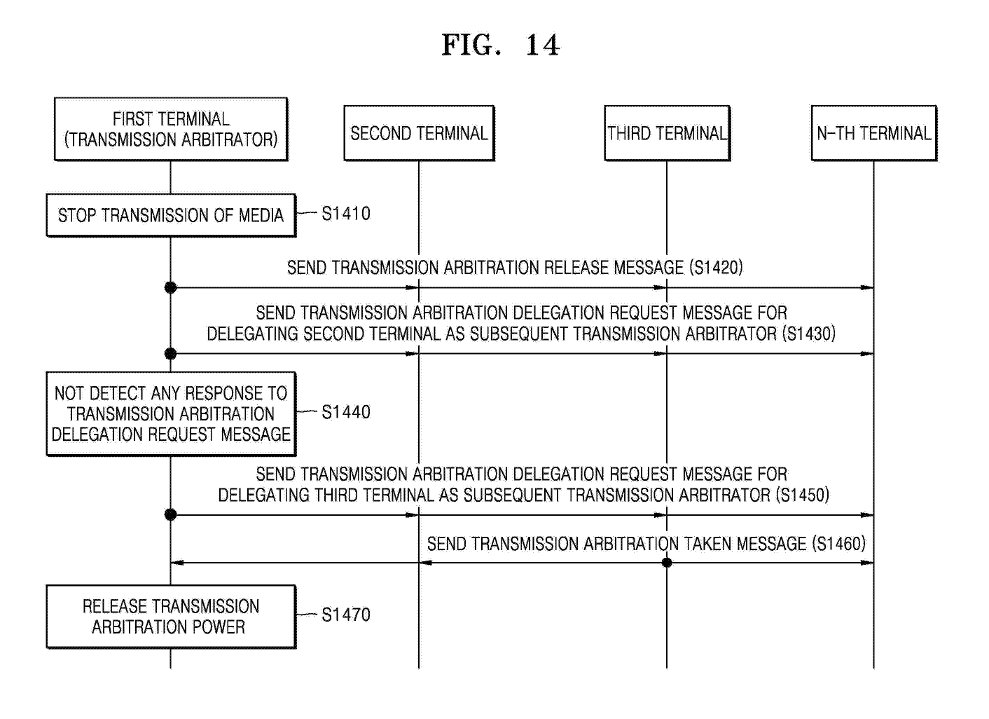

FIG. 14 is a flow diagram of a method in which a terminal releases transmission arbitration power by using a transmission arbitration power delegation request, according to an embodiment of the present disclosure.

Referring to FIG. 14, initially, an off-network group communication is established and at least one terminal other than a first terminal, being a current transmission arbitrator, included in a terminal group is currently transmitting media.

In step S1410, the first terminal may stop transmission of the media. Then, the first terminal may only stop transmission of the media but may not release its own transmission arbitration power.

In step S1420, the first terminal may send a transmission arbitration release message to the terminal group (e.g., a second terminal, a third terminal, . . . , and an n^{th} terminal).

The transmission arbitration release message according to an embodiment of the present disclosure may indicate that transmission is released as media transmission is completed and that transmission arbitration power is released. The transmission arbitration release message may be sent in unicast or broadcast.

The transmission arbitration release message may include IEs, such as an MCVideo ID of a transmission arbitrator, an MCVideo ID of a delegated transmission arbitrator, and a source identifier. An MCVideo ID of a transmission arbitrator may indicate identification information of a transmission arbitrator, and an MCVideo ID of a delegated transmission arbitrator may indicate identification information of a delegated transmission arbitrator if another terminal that is currently transmitting media exists. A source identifier may indicate an identifier of a communication. For example, if media has been multiplexed, a source identifier may be used to identify media within the multiplexed media.

In step S1430, the first terminal may transmit, to the terminal group, a transmission arbitration delegation request message for delegating, as a subsequent transmission arbitrator, a second terminal that is currently transmitting media. For example, the first terminal may send the transmission arbitration delegation request message to the terminal group in unicast or broadcast.

The transmission arbitration delegation request message may include IEs, such as an MCVideo ID, an MCVideo ID of an arbitrator candidate, and a source identifier. An MCVideo ID may indicate an identifier of a terminal that has requested delegation of transmission arbitration power, and an MCVideo ID of the arbitrator candidate may indicate identification information of a terminal that has supported a transmission arbitrator. A source identifier may indicate an identifier of a communication. For example, if media has been multiplexed, a source identifier may be used to identify media within the multiplexed media.

The first terminal may wait for a confirmation without releasing transmission arbitration power before receiving a response to the transmission arbitration delegation request message.

In step S1440, the first terminal may not detect any response from the second terminal.

In step S1450, the first terminal may transmit, to the terminal group, a transmission arbitration delegation request message for delegating, as a subsequent transmission arbitrator, a third terminal as another terminal that is currently transmitting media. The first terminal may wait for a confirmation without releasing transmission arbitration power before receiving a response to the transmission arbitration delegation request message.

In step S1460, the third terminal may send a transmission arbitration taken message to the terminal group.

In step S1470, if the transmission arbitration taken message is received from the third terminal, the first terminal may release transmission arbitration power.

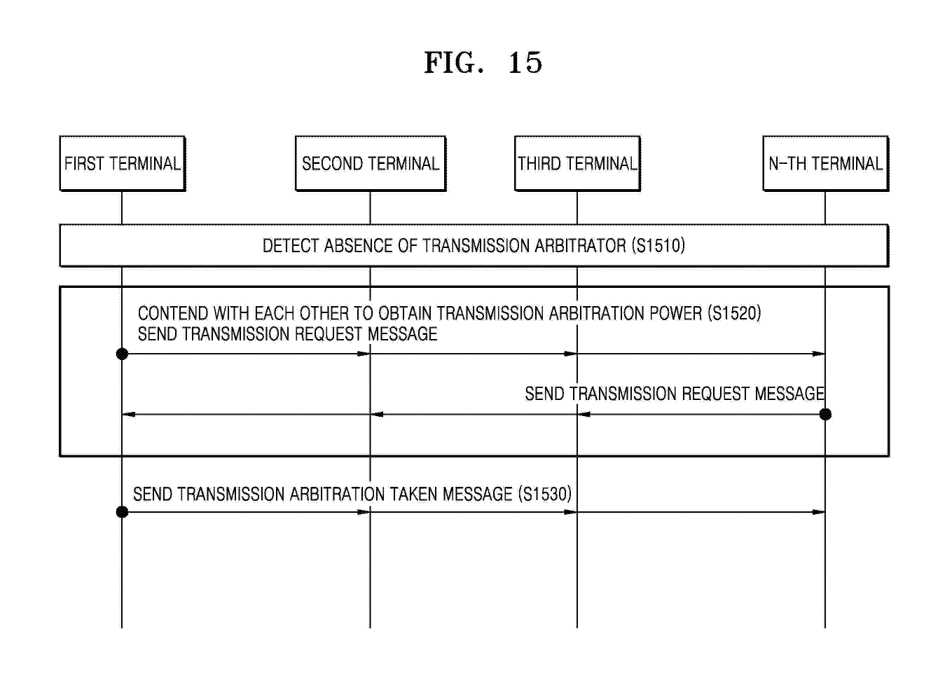

FIG. 15 is a flow diagram of a method of determining a transmission arbitrator, based on a transmission request message, if no transmission arbitrators exist in a terminal group, according to an embodiment of the present disclosure.

Referring to FIG. 15, initially, it is an off-network group communication is established and a current transmission arbitrator is not available in a communication range. For example, if a current transmission arbitrator is out of communication range, the current transmission arbitrator may be unable to communicate with another terminal included in the terminal group. According to an embodiment of the present disclosure, at least one terminal is currently transmitting media and is able to obtain transmission arbitration power.

In step S1510, at least one terminal included in the terminal group may detect an absence of a transmission arbitrator. For example, the at least one terminal may detect an absence of a transmission arbitrator by noticing that transmission control messages are unanswered by any transmission arbitrator.

In step S1520, the at least one terminal included in the terminal group may contend with each other to obtain transmission arbitration power. For example, a first terminal and a fourth terminal from among a plurality of terminals included in the terminal group may send transmission request messages to the terminal group, as each of the first and fourth terminals detects an absence of the transmission arbitrator.

In step S1530, the first terminal may send a transmission arbitration taken message to the terminal group (e.g., a second terminal, a third terminal, . . . , and an n^{th} terminal). The first terminal may compare priority included in the transmission request message received from the fourth terminal to a priority of the first terminal. According to an embodiment of the present disclosure, if it is determined that a priority of the first terminal is greatest among priorities of the first and fourth terminals that have, respectively, sent transmission request messages, the first terminal obtains transmission arbitration power.

However, this is only an example, and, if a plurality of terminals has sent transmission request messages, a synchronization source identifier (SSRC) value instead of a priority may be used as a criterion for selecting a transmission arbitrator from among the plurality of terminals that have sent transmission request messages. According to an embodiment of the present disclosure, based on a combination of a priority and an SSRC value, a transmission arbitrator may be selected from the plurality of terminals that have sent transmission request messages.

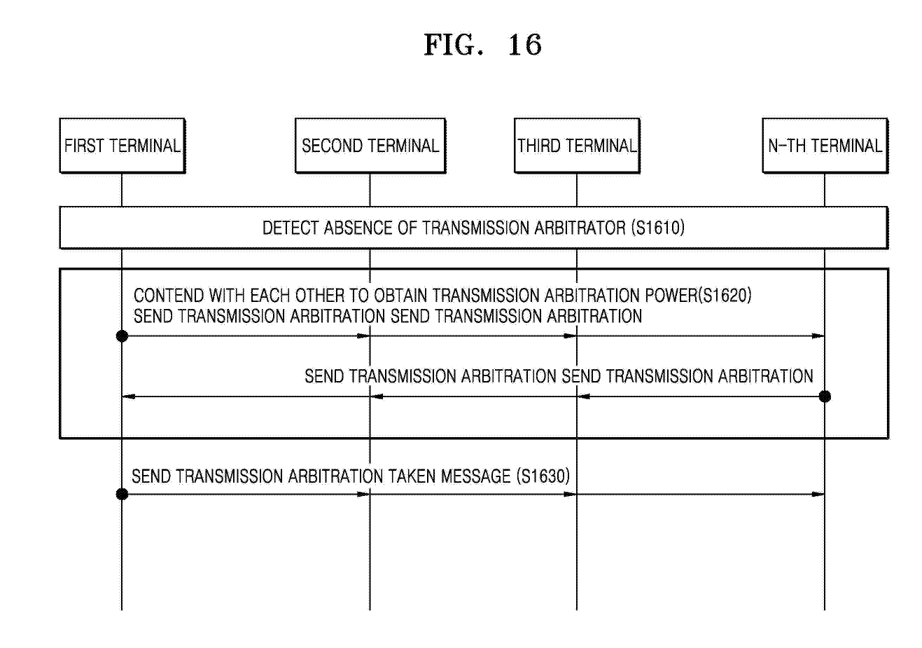

FIG. 16 is a flow diagram of a method of determining a transmission arbitrator, based on a transmission request message, if no transmission arbitrators exist in a terminal group, according to an embodiment of the present disclosure.

Referring to FIG. 16, initially, an off-network group communication is established and a current transmission arbitrator is not available in a communication range. For example, if a current transmission arbitrator is out of communication range, the current transmission arbitrator may be unable to communicate with another terminal included in the terminal group. According to an embodiment of the present disclosure, at least one terminal is currently transmitting media and is able to obtain transmission arbitration.

In step S1610, at least one terminal included in the terminal group may detect an absence of a transmission arbitrator. For example, the at least one terminal may detect an absence of a transmission arbitrator by noticing that transmission control messages are unanswered by any transmission arbitrator.

In step S1620, as an absence of a transmission arbitrator is detected, the at least one terminal included in the terminal group may contend with each other to obtain transmission arbitration power. For example, a first terminal and a fourth terminal from among a plurality of terminals included in the terminal group may send transmission arbitration delegation request messages to the terminal group, as each of the first and fourth terminals detects an absence of the transmission arbitrator.

In step S1630, the first terminal may send a transmission arbitration taken message to the terminal group. The first terminal may compare a priority included in the transmission arbitration delegation request message received from the fourth terminal to a priority of the first terminal. According to an embodiment of the present disclosure, if it is determined that a priority of the first terminal is greatest among priorities of the first and fourth terminals that have, respectively, sent the transmission arbitration delegation request messages, the first terminal obtains transmission arbitration power.

However, this is only an example, and, if a plurality of terminals have sent transmission arbitration delegation request messages, an SSRC value instead of a priority may be used as a criterion for selecting a transmission arbitrator from among the plurality of terminals that have sent transmission arbitration delegation request messages. According to an embodiment of the present disclosure, based on a combination of a priority and an SSRC value, a transmission arbitrator may be selected from the plurality of terminals that have sent transmission arbitration delegation request message.

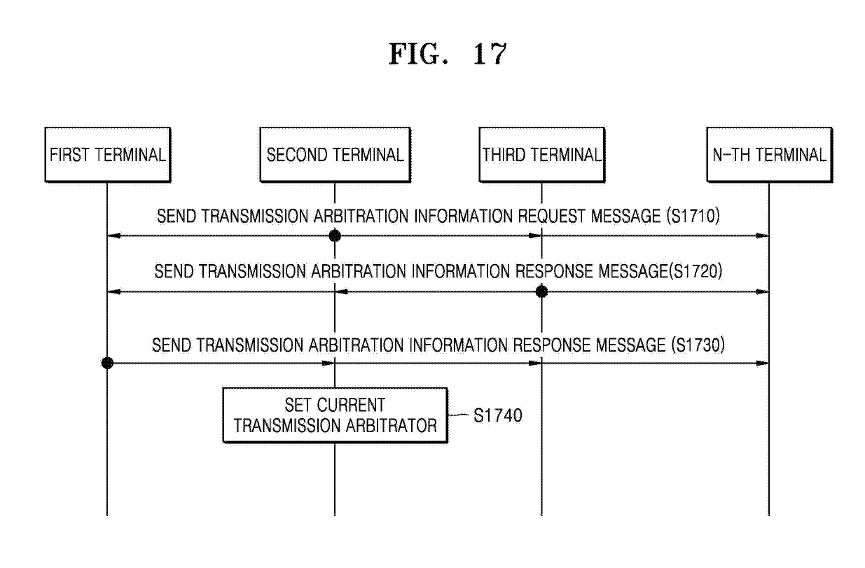

FIG. 17 is a flow diagram of a method in which a terminal requests information of a transmission arbitrator, according to an embodiment of the present disclosure.

Referring to FIG. 17, initially, an off-network group communication is established and at least one terminal that is currently transmitting media exists in a terminal group.

In step S1710, a second terminal may send a transmission arbitration information request message to the terminal group (e.g., a first terminal, a third, terminal, . . . , and an n^{th} terminal). The second terminal may not recognize a transmission arbitrator if the second terminal participates in the terminal group later than the other terminals. Accordingly, the second terminal may send a transmission arbitration delegation information request message to the terminal group in unicast or broadcast, in order to obtain information of the transmission arbitrator.

The transmission arbitration information request message may include IEs, such as an MCVideo ID and a source identifier. an MCVideo ID may indicate identification information of a terminal that has requested transmission arbitration information. A source identifier may indicate an identifier of a communication. For example, if media has been multiplexed, a source identifier may be used to identify media within the multiplexed media.

In step S1720, a third terminal as a transmission arbitrator may send a transmission arbitration information response message to the terminal group (e.g., a first terminal, a second terminal, . . . , and an n^{th} terminal). The transmission arbitration information response message may be sent in unicast or broadcast.

The transmission arbitration information response message may include IEs, such as an MCVideo ID and a source identifier. an MCVideo ID may indicate identification information of a transmission arbitrator. A source identifier may indicate an identifier of a communication. For example, if media has been multiplexed, a source identifier may be used to identify media within the multiplexed media.

In step S1730, a first terminal as a transmission arbitrator may send a transmission arbitration information response message to the terminal group.

According to an embodiment of the present disclosure, if the first terminal is out of the coverage of the third terminal and the third terminal is out of the coverage of the first terminal, a plurality of transmission arbitrators exist. For example, if a second terminal is an edge user located on a boundary between the coverages of the first terminal and the third terminal, the second terminal may receive a transmission arbitration information response message from each of the first terminal and the third terminal.

In step S1740, the second terminal may set a current transmission arbitrator, based on the received transmission arbitration information response messages.

During communication between terminals, radio interference may become an important issue. To avoid or warn of interference, other terminals in the proximity of a terminal that has sent a transmission request message, according to an embodiment of the present disclosure, may send transmission warning messages that indicate that a greater amount of interference than a maximum amount of interference allowed in the terminal group may occur due to the transmission by the terminal.

In response to the transmission warning message, a terminal according to an embodiment of the present disclosure may determine whether to transmit media, based on at least one of user's indication, a pre-stored auto mode (e.g., a transmission commencement mode), and transmission priority.

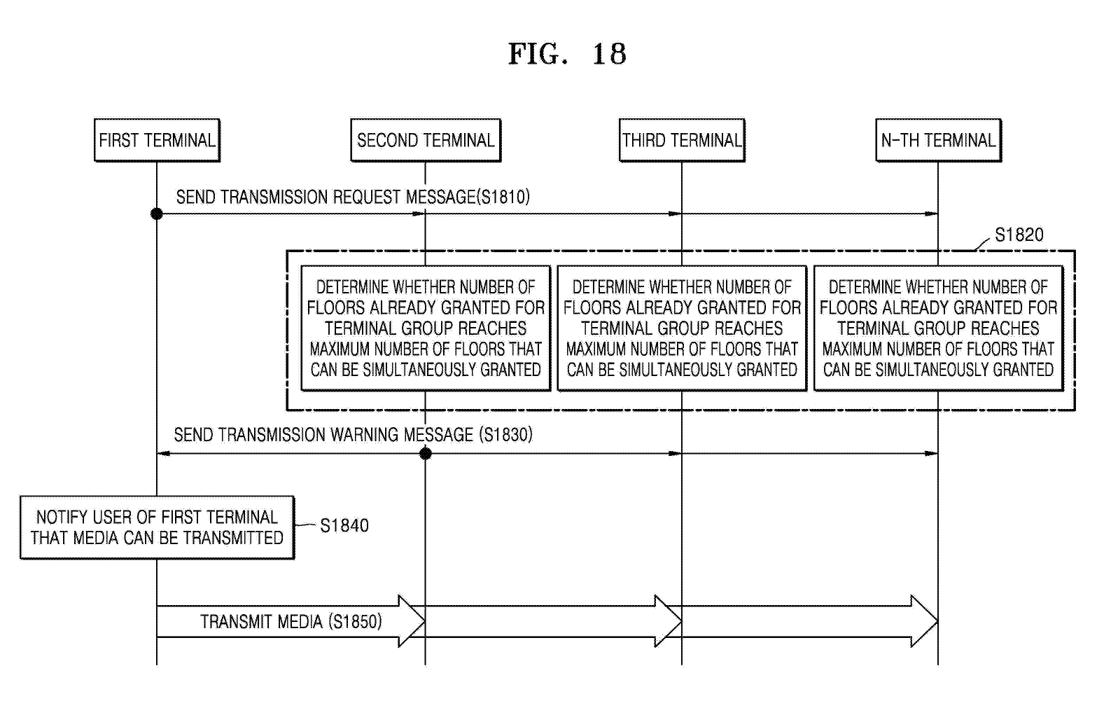

An operation of the terminal that has received the transmission warning message is described below with reference to FIGS. 18-21.

FIG. 18 is a flow diagram of a method in which a terminal transmits media, based on a user's indication, in response to a transmission warning message that warns of an interference occurrence, according to an embodiment of the present disclosure.

Referring to FIG. 18, as a first terminal detects a presence of a transmission arbitrator within a terminal group, the first terminal may send a transmission request message to the terminal group. According to an embodiment of the present disclosure, an off-network group communication is established.

In step S1810, a first terminal may send a transmission request message to the terminal group (e.g., a second terminal, a third terminal, . . . , and an n^{th} terminal).

In step S1820, each of a plurality of terminals in the terminal group that has received the transmission request message may determine whether a number of floors already granted for the terminal group reaches a maximum number of floors capable of being granted simultaneously.

In step S1830, if the number of floors already granted for the terminal group reaches the maximum number of floors capable of being granted simultaneously, at least one of the plurality of terminals that has received the transmission request message, namely, a second terminal, may send a transmission warning message to the terminal group. The transmission warning message may indicate that the number of floors already granted for the terminal group has reached the maximum number of floors that can be granted simultaneously.

In step S1840, the first terminal may notify a user of the first terminal that, if the first terminal transmits the media, other terminals in the terminal group may be interfered with.

In step S1850, the first terminal may transmit the media to the terminal group.

The first terminal may transmit the media to the terminal group according to an indication of the user of the first terminal. Then, the first terminal may already have the indication of the user in order to perform automatic transmission.

According to an embodiment of the present disclosure, if the first terminal does not receive a transmission arbitration control message but receives a transmission warning message in response to the transmission request message, the first terminal may send a transmission arbitration taken message and serve as a transmission arbitrator, according to the indication of the user of the first user.

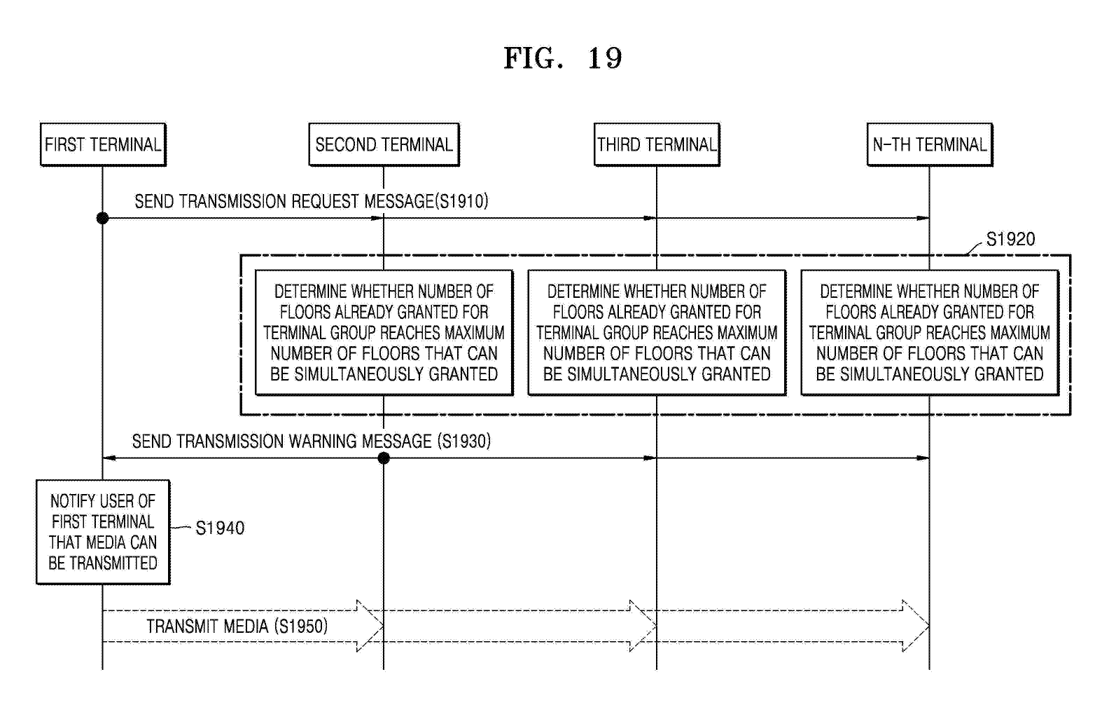

FIG. 19 is a flow diagram of a method in which a terminal determines transmission of media, based on a user's indication, in response to a transmission warning message that warns of an interference occurrence, according to an embodiment of the present disclosure.

Referring to FIG. 19, as a first terminal detects a presence of a transmission arbitrator within a terminal group, the first terminal may send a transmission request message to the terminal group (e.g., a second terminal, a third terminal, . . . , and an n^{th} terminal). According to an embodiment of the present disclosure, an off-network group communication is established.

In step S1910, the first terminal may send a transmission request message to the terminal group.

In step S1920, each of a plurality of terminals in the terminal group that have received the transmission request message may determine whether a number of floors already granted for the terminal group reaches a maximum number of floors capable of being granted simultaneously.

In step S1930, if the number of floors already granted for the terminal group reaches the maximum number of floors capable of being granted simultaneously, at least one of the plurality of terminals that has received the transmission request message, namely, a second terminal, may send a transmission warning message to the terminal group. The transmission warning message may indicate that the number of floors already granted for the terminal group has reached the maximum number of floors that can be granted simultaneously.

In step S1940, the first terminal may notify a user of the first terminal that, if the first terminal transmits media, other terminals in the terminal group may be interfered with.

In step S1950, the first terminal may determine whether to transmit the media to the terminal group according to an indication of the user of the first terminal. For example, if the first terminal instructs the user of the first terminal to transmit the media, the first terminal may transmit the media to the terminal group. According to an embodiment of the present disclosure, if the first terminal instructs the user of the first terminal to not transmit the media in order to avoid an interference occurrence, the first terminal may not transmit the media to the terminal group.

According to an embodiment of the present disclosure, if the first terminal does not receive a transmission arbitration control message but receives a transmission warning message in response to the transmission request message, the first terminal may send a transmission arbitration taken message and serve as a transmission arbitrator, according to an indication of the user of the first terminal.

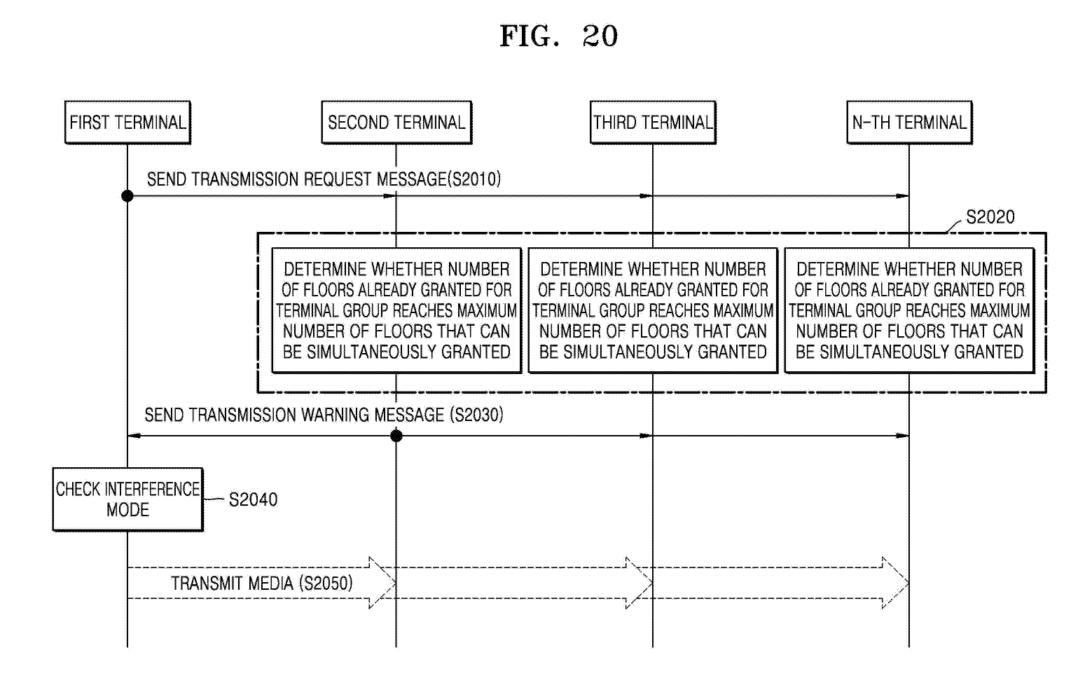

FIG. 20 is a flow diagram of a method in which a terminal determines a transmission of media, based on an interference mode, in response to a transmission warning message that warns of an interference occurrence, according to an embodiment of the present disclosure.

Referring to FIG. 20, if a first terminal detects a presence of a transmission arbitrator within a terminal group, the first terminal may send a transmission request message to the terminal group. According to an embodiment of the present disclosure, an off-network group communication is established.

In step S2010, the first terminal may send a transmission request message to the terminal group (e.g., a second terminal, a third terminal, . . . , and an n^{th} terminal).

In step S2020, each of a plurality of terminals in the terminal group that have received the transmission request message may determine whether a number of floors already granted for the terminal group reaches a maximum number of floors capable of being granted simultaneously.

In step S2030, if the number of floors already granted for the terminal group reaches the maximum number of floors capable of being granted simultaneously, at least one of the plurality of terminals that have received the transmission request message, namely, a second terminal, may send a transmission warning message to the terminal group. The transmission warning message may indicate that the number of floors already granted for the terminal group has reached the maximum number of floors that can be granted simultaneously.

In step S2040, in response to the transmission warning message, the first terminal may check an interference mode of the first terminal to determine whether the first terminal is to transmit media. The interference mode may indicate whether a terminal that has received the transmission warning message is to transmit the media.

In step S2050, the first terminal may determine whether to transmit the media to the terminal group, based on the interference mode. For example, the first terminal may transmit the media to the terminal group if the interference mode is set to be true. For example, the first terminal may not transmit the media to the terminal group if the interference mode is set to be false.

According to an embodiment of the present disclosure, if the first terminal does not receive a transmission arbitration control message but receives a transmission warning message in response to a transmission request message, the first terminal may send a transmission arbitration taken message and serve as a transmission arbitrator, according to an interference mode.

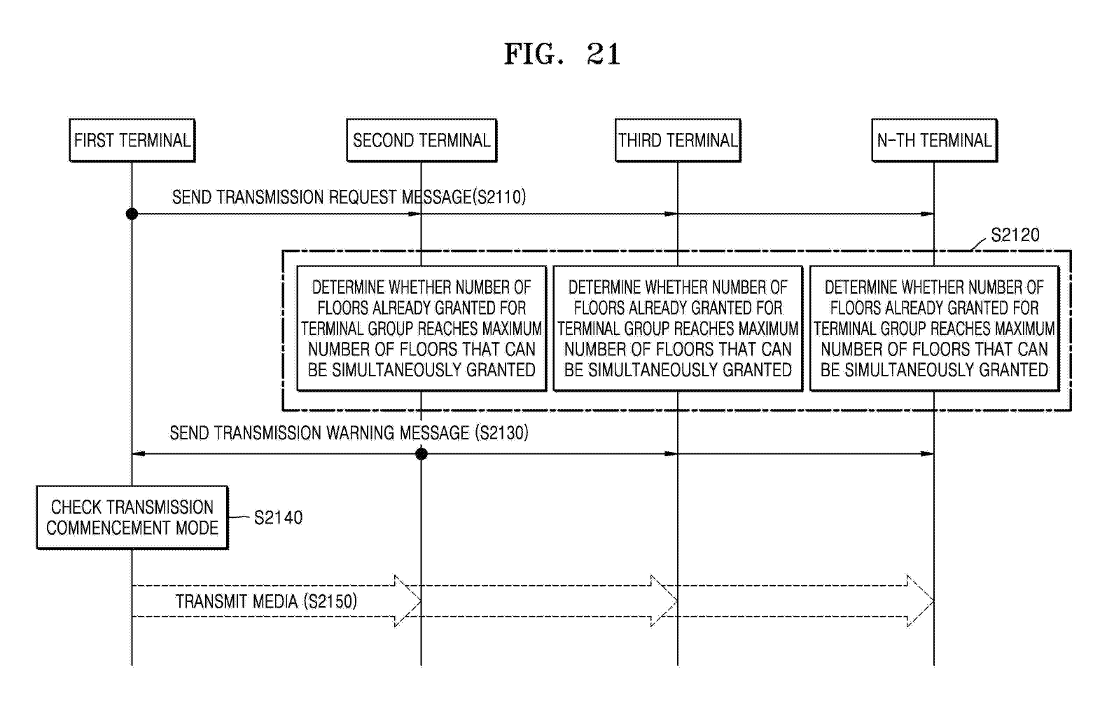

FIG. 21 is a flow diagram of a method in which a terminal determines a transmission of media, based on a transmission commencement mode, in response to a transmission warning message that warns of an interference occurrence, according to an embodiment of the present disclosure.

Referring to FIG. 21, as a first terminal detects a presence of a transmission arbitrator within a terminal group, the first terminal may send a transmission request message to the terminal group. According to an embodiment of the present disclosure, an off-network group communication is established.

In step S2110, the first terminal may send a transmission request message to the terminal group (e.g., a second terminal, a third terminal, . . . , and an n^{th} terminal).

In step S2120, each of a plurality of terminals in the terminal group that have received the transmission request message may determine whether a number of floors already granted for the terminal group reaches a maximum number of floors capable of being granted simultaneously.

In step S2130, if the number of floors already granted for the terminal group reaches the maximum number of floors capable of being granted simultaneously, at least one of the plurality of terminals that have received the transmission request message, namely, a second terminal, may send a transmission warning message to the terminal group. The transmission warning message may indicate that the number of floors already granted for the terminal group has reached the maximum number of floors that can be granted simultaneously.

In step S2140, in response to a transmission warning message, the first terminal may check a transmission commencement mode of the first terminal to determine whether the first terminal is to transmit media. The transmission commencement mode may indicate whether a terminal that has received the transmission warning message is to transmit the media according to a pre-defined user's indication automatically. Accordingly, the user of the first terminal may not determine whether to transmit media whenever the first terminal notifies of a reception of the transmission warning message about transmission interference.

In step S2150, the first terminal may determine whether to transmit media to the terminal group, based on a transmission commencement mode. For example, the first terminal may transmit media to the terminal group if the transmission commencement mode is set to transmit the media. For example, the first terminal may not transmit media to the terminal group if the transmission commencement mode is set to not transmit media.

According to an embodiment of the present disclosure, if the first terminal does not receive a transmission arbitration control message but receives a transmission warning message in response to the transmission request message, the first terminal may send a transmission arbitration taken message and serve as a transmission arbitrator, according to the transmission commencement mode.

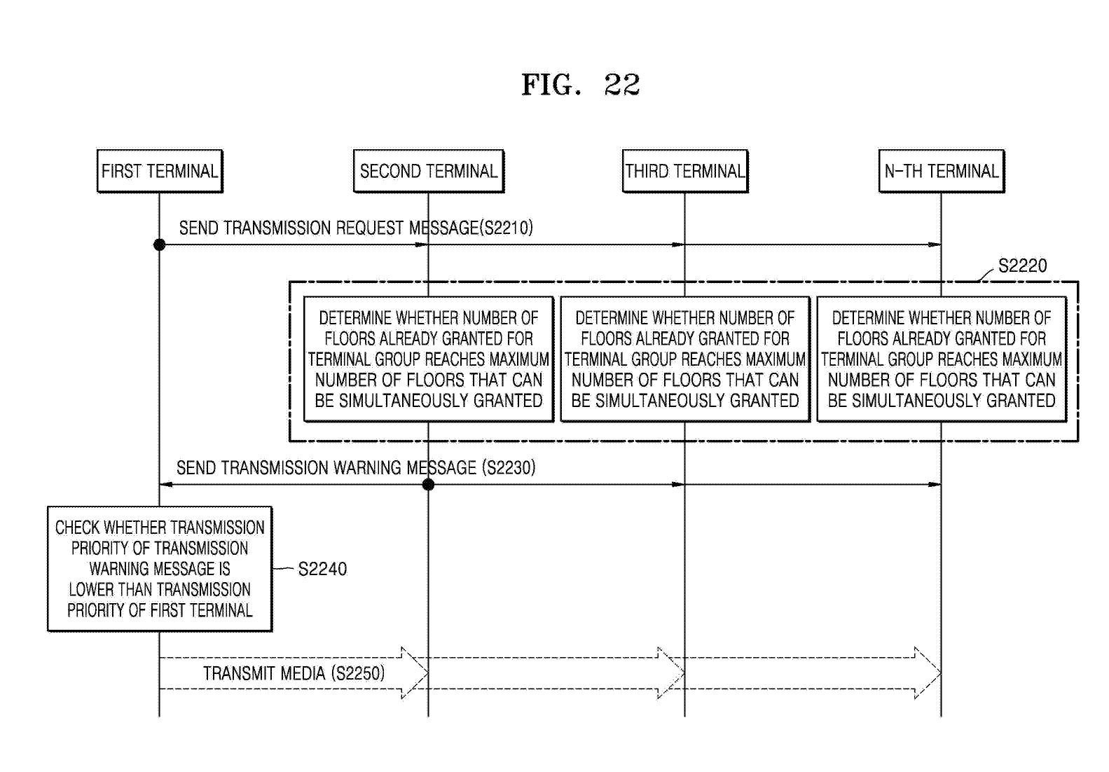

FIG. 22 is a flow diagram of a method in which a terminal determines a transmission of media, based on transmission priority, in response to a transmission warning message that warns of an interference occurrence, according to an embodiment of the present disclosure.

Referring to FIG. 22, as a first terminal detects a presence of a transmission arbitrator within a terminal group, the first terminal may send a transmission request message to the terminal group. According to an embodiment of the present disclosure, an off-network group communication is established.

In step S2210, the first terminal may send a transmission request message to the terminal group (e.g., a second terminal, a third terminal, . . . , and an n^{th} terminal).

In step S2220, each of a plurality of terminals in the terminal group that have received the transmission request message may determine whether a number of floors already granted for the terminal group reaches a maximum number of floors capable of being granted simultaneously.

In step S2230, if the number of floors already granted for the terminal group reaches the maximum number of floors capable of being granted simultaneously, at least one of the plurality of terminals that have received the transmission request message, namely, a second terminal, may send a transmission warning message to the terminal group. The transmission warning message may indicate that the number of floors already granted for the terminal group has reached the maximum number of floors that can be granted simultaneously.

The transmission warning message may include IEs, such as an MCVideo ID and a transmission priority. The MCVideo ID may indicate identification information of a terminal that transmits a transmission warning message or a user of the terminal. The transmission priority may indicate a transmission priority of the terminal that transmits the transmission warning message.

In step S2240, in response to the transmission warning message, the first terminal may determine whether transmission priority of the transmission warning message is less than a transmission priority of the first terminal.

If the first terminal has received a plurality of transmission warning messages, the first terminal may compare transmission priority of each of the plurality of transmission warning messages to the transmission priority of the first terminal. For example, the first terminal may determine whether transmission policy greater than the transmission priority of the first terminal exists among the transmission priorities of the plurality of transmission warning messages.

In step S2250, the first terminal may determine whether to transmit media to the terminal group, based on the transmission priority. For example, if it is determined that the transmission priority of the first terminal is greater than the transmission priority of the transmission warning message, the first terminal may transmit media to the terminal group. The transmission priority of the transmission warning message may include at least one of transmission priority of a terminal that has sent the transmission warning message and transmission priority of another terminal that has granted a floor. for example, if it is determined that the transmission priority of the first terminal is less than the transmission priority of the transmission warning message, the first terminal may not transmit media to the terminal group.

However, this is only an example, and a transmission priority policy is not limited thereto.

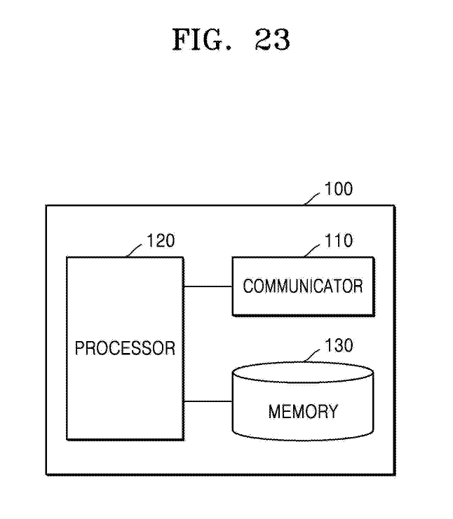

FIG. 23 is a block diagram of the terminal 100 according to an embodiment of the present disclosure.

Referring to FIG. 23, the terminal 100 may include a communicator 110, a processor 120, and a memory 130.

The communicator 110 is connected to the processor 120 and transmits and/or receives a wireless signal.

The communicator 110 receives a transmission request message that requests a floor, which is a right to transmit media, from at least one terminal other than the terminal 100 included in the terminal group. The communicator 110 may send, to the terminal group, a message including information about at least one terminal for which a floor is revoked and a terminal that is granted a floor.

The communicator 110 may send, to the terminal group, a transmission revoked message indicating that the floor of the floor-already-granted terminal is revoked. The communicator 110 may also send, to the terminal group, a transmission granted message indicating that the other terminal that has sent the transmission request message is granted a floor. The communicator 110 may receive media from the other terminal that has sent the transmission request message.

If the terminal 100 is an arbitrator terminal and it is determined that priority of the arbitrator terminal is less than a priority of the other terminal that has sent the transmission request message, the communicator 110 may send, to the terminal group, a transmission revoked message indicating that a floor of the arbitrator terminal is revoked. The communicator 100 may also send, to the terminal group, a transmission granted message indicating that the other terminal that has sent the transmission request message has obtained at least one of a floor and transmission arbitration power.

The communicator 110 may receive a transmission arbitration taken message indicating that the other terminal that has sent the transmission request message has obtained the transmission arbitration power from the other terminal that has sent the transmission request message. The communicator 110 may receive media from the other terminal that has sent the transmission request message.

If the number of floors granted before the reception of the transmission request message is less than a maximum number of floors preset for the terminal group, the communicator 110 may send, to the terminal group, a transmission granted message indicating that the floor of the other terminal that has sent the transmission request message is granted.

According to an embodiment of the present disclosure, the communicator 110 may send, to the terminal group, a message indicating that transmission arbitration power is delegated to another terminal that is currently transmitting media from among the plurality of terminals included in the terminal group.

For example, the communicator 110 may send, to the terminal group, a first transmission arbitration release message indicating that transmission arbitration power is delegated to a first terminal that is currently transmitting the media from among the plurality of terminals. If the communicator 110 does not receive a response to the first transmission arbitration release message, the communicator 110 may send, to the terminal group, a second transmission arbitration release message indicating that transmission arbitration power is delegated to another terminal that is currently transmitting media, namely, a second terminal.

This is only an example, and the communicator 110 may transmit or receive at least one of a transmission request message, a transmission granted message, a transmission release message, a transmission rejected message, a transmission revoked message, a transmission taken message, a transmission arbitration taken message, a transmission arbitration release message, a transmission arbitration information request message, a transmission arbitration information response message, a transmission arbitration delegation request message, and a transmission warning message that are necessary for off-network communication, according to a determination by the processor 120. The communicator 110 may transmit or receive media.

The communicator 110 may include a baseband circuit for processing a wireless signal.

The processor 120 implements a proposed function, process, and/or method. Operations of the terminal 100 may be implemented by the processor 120. The processor 120 may control a process, such as floor control and media transmission, necessary for off-network communication, according to the description above with reference to FIGS. 1-22.

In response to the transmission request message, the processor 120 may determine a terminal for which a floor is revoked and a terminal that is granted a floor, within the terminal group, based on a result of a comparison between a number of floors granted before the reception of the transmission request message and a maximum number of floors preset for the terminal group.

If the number of floors granted before the reception of the transmission request message is equal to the maximum number of floors preset for the terminal group, the processor 120 may compare a priority of the other terminal that has sent the transmission request message with a priority of a terminal that has been granted a floor before the reception of the transmission request message, namely, the floor-already-granted terminal.

If the priority of the floor-already-granted terminal is less than the priority of the other terminal that has sent the transmission request message, the processor 120 may determine the floor-already-granted terminal as the terminal for which a floor is revoked and may determine the other terminal that has sent the transmission request message as the terminal that is granted a floor.

In response to the transmission arbitration taken message, the processor 120 may release transmission arbitration power of the terminal 100.

According to an embodiment of the present disclosure, the processor 120 may enable a terminal having transmission arbitration power of the terminal group to stop transmitting media. If the processor 120 receives a transmission arbitration taken message as a response to a transmission arbitration release message indicating that transmission arbitration power is delegated to the other terminal that is currently transmitting the media, the processor 120 may release the transmission arbitration power of the terminal 100.

The memory 130 is connected to the processor 120 and stores a protocol or parameter for an operation. For example, the memory 130 may store information about a terminal serving as a transmission arbitrator, priority of a terminal, user's indication, an interference mode, and a transmission commencement mode.

A processor may include application-specific integrated circuits (ASICs), other chipsets, logic circuits, and/or data processing devices. A memory may include read-only memory (ROM), random access memory (RAM), flash memory, memory cards, storage media, and/or other storage devices. The computer readable recording medium can also be distributed over network coupled computer systems so that the computer readable code is stored and executed in a distributed fashion. This media can be read by the computer, stored in the memory, and executed by the processor. If an embodiment of the present disclosure is implemented as software, the above-described technique may be implemented as a module (process, function, or the like) of performing the above-described function. The module may be stored in the memory and executed by the processor. The memory may be within or outside the processor, and may be connected to the processor via various well-known means.

Although methods in the above-described system are a series of operations or blocks and thus are described based on flow diagrams, the present disclosure is not limited to the order of the operations, and operations may be performed in a different order from that described above or may be performed simultaneously. Moreover, it will be understood by one of ordinary skill in the art that the operations illustrated in a flow diagram are not exclusive and thus another operation may be included in the illustrated operations or one or more operations may be deleted without affecting the scope of the present disclosure.

The aforementioned embodiments of the present disclosure include various aspects of the accompanying drawings. Although all possible combinations for indicating various aspects may not be described, one of ordinary skill in the art will understand that other combinations are possible. Accordingly, the present disclosure is intended to include all other replacements, corrections, and modifications within the scope of the present disclosure as defined by the appended claims and their equivalents.

All references, including publications, patent applications, and patents, cited herein are hereby incorporated by reference to the same extent as if each reference were individually and specifically indicated to be incorporated by reference and were set forth in its entirety herein.

To promote understanding of one or more embodiments of the present disclosure, reference has been made to the embodiments illustrated in the accompanying drawings, and certain language has been used to describe these embodiments. However, no limitation of the scope of the present disclosure is intended by this certain language, and embodiments of the present disclosure are not intended to be construed to encompass all embodiments that would normally occur to one of ordinary skill in the art.

The aforementioned embodiments of the present disclosure may be described in terms of functional block components and various processing operations. Such functional blocks may be realized by any number of hardware and/or software components configured to perform certain functions. For example, the aforementioned embodiments of the present disclosure may employ various integrated circuit (IC) components, e.g., memory elements, processing elements, logic elements, look-up tables, and the like, which may carry out a variety of functions under the control of one or more microprocessors or other control devices. Similarly, where the elements of the aforementioned embodiments are implemented using software programming or software elements, the disclosed embodiments may be implemented with any programming or scripting language such as C, C++, Java, assembler language, or the like, with the various algorithms being implemented with any combination of data structures, objects, processes, routines or other programming elements. Functional aspects may be implemented in algorithms that are executed on one or more processors. Furthermore, the embodiments described herein could employ any number of techniques according to the related art for electronics configuration, signal processing and/or control, data processing and the like. The terms “mechanism,” “element,” “means,” and “configuration” are used broadly and are not intended to be limited to mechanical or physical embodiments, but are intended to include software routines in conjunction with processors, etc.

The certain implementations shown and described herein are illustrative embodiments of the present disclosure but are not intended to otherwise limit the scope of the present disclosure in any way. For the sake of brevity, electronics, control systems, software development and other functional aspects of the systems according to the related art may not be described in detail. Furthermore, connecting lines, or connectors shown in the various accompanying drawings are intended to indicate various functional relationships and/or physical or logical couplings between the various elements. It should be noted that many alternative or additional functional relationships, physical connections or logical connections may be present in a practical apparatus. Moreover, no item or component is essential to the practice of the embodiments of the present disclosure described herein unless the element is specifically described as “essential” or “critical”.

What is claimed is:

1. A method, performed by a terminal, of performing communication, the method comprising:
receiving a transmission request message that requests a floor, wherein the floor is a right to transmit media, from at least one terminal, other than the terminal, included in a terminal group;
in response to the transmission request message, determining a terminal for which a floor is revoked and a terminal that is granted a floor, within the terminal group, based on a result of a comparison between a number of floors granted before reception of the transmission request message and a maximum number of floors preset for the terminal group; and
sending, to the terminal group, a message including information about the terminal for which a floor is revoked and the terminal that is granted a floor.

2. The method of claim 1, wherein determining the terminal for which a floor is revoked and the terminal that is granted a floor comprises, if the number of floors granted before the reception of the transmission request message is equal to the maximum number of floors preset for the terminal group, comparing a priority of the at least one other terminal that has sent the transmission request message with a priority of a terminal that has been granted a floor before the reception of the transmission request message, namely, a floor-already-granted terminal.

3. The method of claim 2, wherein determining the terminal for which a floor is revoked and the terminal that is granted a floor comprises, if the priority of the floor-already-granted terminal is less than the priority of the at least one other terminal that has sent the transmission request message, determining the floor-already-granted terminal as the terminal for which a floor is revoked and determining the at least one other terminal that has sent the transmission request message, as the terminal that is granted a floor.

4. The method of claim 3, wherein
sending, to the terminal group, a message comprises:
sending, to the terminal group, a floor-revoked message indicating that the floor of the floor-already-granted terminal is revoked;
sending, to the terminal group, a floor-granted message indicating that the floor of the at least one other terminal that has sent the transmission request message is granted, and
further comprises receiving media from the at least one other terminal that has sent the transmission request message.

5. The method of claim 2, wherein
the terminal has been granted the floor and is an arbitrator terminal having transmission arbitration power over the terminal group, and
sending, to the terminal group, a message comprises:
if it is determined that a priority of the arbitrator terminal is less than the priority of the at least one other terminal that has sent the transmission request message, sending, to the terminal group, a floor-revoked message indicating that the floor of the arbitrator terminal is revoked; and
sending, to the terminal group, a floor-granted message indicating that the at least one other terminal that has sent the transmission request message has obtained a floor and transmission arbitration power, and
if the floor-revoked message is transmitted, media transmission by the terminal is stopped.

6. The method of claim 5, further comprising:
receiving a transmission arbitration taken message indicating that the at least one other terminal that has sent the transmission request message has obtained the transmission arbitration power, from the at least one other terminal that has sent the transmission request message;
in response to the transmission arbitration taken message, releasing the transmission arbitration power of the terminal; and
receiving media from the at least one other terminal that has sent the transmission request message.

7. The method of claim 1, wherein sending, to the terminal group, a message comprises, if the number of floors granted before the reception of the transmission request message is less than the maximum number of floors preset for the terminal group, sending, to the terminal group, a floor-granted message indicating that the at least one other terminal that has sent the transmission request message is granted a floor.

8. A method, performed by a terminal, of performing communication, the method comprising:
stopping transmission of media by a terminal that has transmission arbitration power of a terminal group;
sending, to the terminal group, a message indicating that the transmission arbitration power is delegated to another terminal that is currently transmitting media from among a plurality of terminals included in the terminal group; and
releasing the transmission arbitration power of the terminal, based on whether a response to the sent message is received.

9. The method of claim 8, wherein
sending, to the terminal group, a message comprises:
sending, to the terminal group, a first transmission arbitration release message indicating that transmission arbitration power is delegated to a first terminal that is currently transmitting media from among the plurality of terminals; and
if a response to the first transmission arbitration release message is not received, sending, to the terminal group, a second transmission arbitration release message indicating that transmission arbitration power is delegated to another terminal that is currently transmitting media, namely, a second terminal, and
releasing of the transmission arbitration power comprises if a transmission arbitration taken message is received from the second terminal, releasing the transmission arbitration power of the terminal.

10. A terminal for performing communication, the terminal comprising:
a communicator configured to receive a transmission request message that requests a floor, wherein a floor is a right to transmit media, from at least one terminal, other than the terminal, included in a terminal group; and
a processor configured to, in response to the transmission request message, determine a terminal for which a floor is revoked and a terminal that is granted a floor, within the terminal group, based on a result of a comparison between a number of floors granted before reception of the transmission request message and a maximum number of floors preset for the terminal group,
wherein the communicator sends, to the terminal group, a message including information about at least one of the terminal for which a floor is revoked and the terminal that is granted a floor.

11. The terminal of claim 10, wherein, if the number of floors granted before the reception of the transmission request message is equal to the maximum number of floors preset for the terminal group, the processor is further configured to compare a priority of the at least one other terminal that has sent the transmission request message with a priority of a terminal that has been granted a floor before the reception of the transmission request message, namely, a floor-already-granted terminal.

12. The terminal of claim 11, wherein, if the priority of the floor-already-granted terminal is less than the priority of the at least one other terminal that has sent the transmission request message, the processor is further configured to determine the floor-already-granted terminal as the terminal for which a floor is revoked and determine the at least one other terminal that has sent the transmission request message, as the terminal that is granted a floor.

13. The terminal of claim 11, wherein the communicator is further configured to send, to the terminal group, a floor-revoked message indicating that the floor of the floor-already-granted terminal is revoked, send, to the terminal group, a transmission granted message indicating that the at least one other terminal that has sent the transmission request message is granted a floor, and receive media from the at least one other terminal that has sent the transmission request message.

14. The terminal of claim 11, wherein
the terminal has been granted the floor and is an arbitrator terminal having transmission arbitration power of the terminal group,
if it is determined that a priority of the arbitrator terminal is less than the priority of the at least one other terminal that has sent the transmission request message, the communicator is further configured to send, to the terminal group, a floor-revoked message indicating that the floor of the arbitrator terminal is revoked, and send, to the terminal group, a floor-granted message indicating that the at least one other terminal that has sent the transmission request message has obtained a floor and transmission arbitration power, and
if the transmission revoked message is transmitted, the media transmission by the terminal is stopped.

15. The terminal of claim 14, wherein
the communicator is further configured to receive a transmission arbitration taken message indicating that the at least one other terminal that has sent the transmission request message has obtained the transmission arbitration power, from the at least one other terminal that has sent the transmission request message, and to receive media from the at least one other terminal that has sent the transmission request message, and
in response to the transmission arbitration taken message, the processor is further configured to release the transmission arbitration power of the terminal.

16. The terminal of claim 10, wherein, if the number of floors granted before the reception of the transmission request message is less than the maximum number of floors preset for the terminal group, the communicator is further configured to send, to the terminal group, a transmission granted message indicating that the at least one other terminal that has sent the transmission request message is granted a floor.

17. A terminal for performing communication, the terminal comprising:
a processor configured to stop transmitting media by a terminal that has transmission arbitration power of a terminal group; and
a communicator configured to send, to the terminal group, a message indicating that the transmission arbitration power is delegated to another terminal that is currently transmitting media from among a plurality of terminals included in the terminal group,
wherein the processor is further configured to release the transmission arbitration power of the terminal, based on whether a response to the sent message is received.

18. The terminal of claim 17, wherein
the communicator is further configured to send, to the terminal group, a first transmission arbitration release message indicating that transmission arbitration power is delegated to a first terminal that is currently transmitting the media from among the plurality of terminals , and, if the communicator does not receive a response to the first transmission arbitration release message, the communicator is further configured to send, to the terminal group, a second transmission arbitration release message indicating that arbitration is delegated to another terminal that is currently transmitting media, namely, a second terminal, and
if a transmission arbitration taken message is received from the second terminal, the processor is configured to release the transmission arbitration power of the terminal.

19. A non-transitory computer-readable recording medium having recorded thereon a computer program, which, if executed by a computer, performs the method of claim 1.
